(19) United States
(12) Patent Application Publication
(10) Pub. No.: US 2019/0188793 A1
(43) Pub. Date: Jun. 20, 2019

(54) SYSTEM AND METHOD OF PROVIDING ESCROW WALLETS AND CLOSING WALLETS FOR TRANSACTIONS

(71) Applicant: TEMPLUM, INC., New York, NY (US)

(72) Inventors: Vincent MOLINARI, Laurel Hollow, NY (US); Christopher PALLOTTA, New York, NY (US); Joseph LATONA, Monroe Township, NJ (US)

(21) Appl. No.: 16/284,579

(22) Filed: Feb. 25, 2019

Related U.S. Application Data
(62) Division of application No. 16/126,954, filed on Sep. 10, 2018.
Application No. 16/126,954 is a continuation of application No. 15/958,801, filed on Apr. 20, 2018.
Application No. 15/958,801 is a division of application No. 16/126,954, filed on Sep. 10, 2018.
(60) Provisional application No. 62/556,568, filed on Sep. 11, 2017.
(60) Provisional application No. 62/560,267, filed on Sep. 19, 2017.

(51) Int. Cl. G06Q 40/04; G06Q 40/06; G06Q 40/02; G06Q 20/06; G06Q 20/22; H04L 9/06

(52) U.S. Cl. CPC G06Q 40/04; G06Q 40/06; G06Q 40/02; H04L 2209/38; G06Q 20/223; H04L 9/0637; G06Q 20/06

(57) ABSTRACT

A method includes creating a seller escrow wallet. The seller escrow wallet only displays a content of the wallet, is non-custodial, maintains an ability to return tokens stored within the wallet to an original account via a request, transfers tokens purchased by the seller to the wallet, and utilizes a master wallet to facilitate a transfer of the tokens from the seller wallet to a buyer wallet associated with the buyer. Upon a sale of the tokens, the method includes moving the tokens from the seller wallet to the master wallet using addresses that identify at least one of the seller and the buyer, receiving a payment at the master wallet from the buyer for the tokens and upon receiving the payment at the master wallet, releasing the tokens to the buyer and transferring the payment to the seller.

### PRIORITY

This application is a divisional of U.S. patent application Ser. No. 16/126,954, filed Sep. 10, 2018, which is a continuation of U.S. application Ser. No. 15/958,801, filed Apr. 20, 2018, which claims priority to U.S. Provisional Application No. 62/556,568, filed Sep. 11, 2017, the contents of each of which are herein incorporated by reference in their entireties.

This application is a divisional of U.S. patent application Ser. No. 16/126,954, filed Sep. 10, 2018, which claims priority to U.S. Provisional Application No. 62/560,267, filed Sep. 19, 2017, the content of which are herein incorporated by reference in their entirety.

### RELATED APPLICATIONS

The present application is related to U.S. patent application Ser. No. 16/126,898, filed Sep. 10, 2018 (Attorney Docket No. 155-0002), U.S. patent application Ser. No. 16/126,929, filed Sep. 10, 2018 (Attorney Docket, 155-0003), and U.S. patent application Ser. No. 16/126,975, filed Sep. 10, 2018 (Attorney Docket 155-0005). Each of these applications is incorporated herein by reference in its entirety.

### TECHNICAL FIELD

The present disclosure relates to the use of escrow wallets, escrow closing wallets or transfer agents, in escrow services related to initial coin offerings or other token offerings.

### BACKGROUND

In the rapid evolution of the acceptance of initial coin offerings (ICOs) and tokenized product offerings, or any other digital asset offerings, there currently exists significant confusion about, lack of understanding of, and disregard for the manner in which monies are aggregated into tokens, and what a token actually represents. Further, there are issues with respect to whether entities holding any assets associated with an ICO or similar offering are acting as custodians.

A custodian is typically a financial institution that holds customers' securities for safekeeping to minimize the risk of their theft or loss. A custodian holds securities and other assets in electronic or physical form. Since they are responsible for the safety of assets and securities that may be worth hundreds of millions or even billions of dollars, custodians generally tend to be large and reputable firms. In some cases, with ICOs and other new technologies, the issuers of blockchain based tokens don't have access to regular custodial services.

### BRIEF DESCRIPTION OF THE DRAWINGS

In order to describe the manner in which the above-recited and other advantages and features of the disclosure can be obtained, a more particular description of the principles briefly described above will be rendered by reference to specific embodiments thereof which are illustrated in the appended drawings. Understanding that these drawings depict only exemplary embodiments of the disclosure and are not therefore to be considered to be limiting of its scope, the principles herein are described and explained with additional specificity and detail through the use of the accompanying drawings in which:

FIG. 1 illustrates an example system configuration;

FIG. 2A illustrates a computer-implemented method embodiment;

FIG. 2B illustrates another method embodiment;

FIG. 2C illustrates another method embodiment;

FIG. 2D illustrates another method embodiment related to timing concepts;

FIG. 2E illustrates another method embodiment related to timing concepts;

FIG. 3 illustrates an example concept of a token;

FIG. 4 illustrates an embodiment of an infrastructure supporting the method claim;

FIG. 5 illustrates another aspect of an initial coin offering with the use of an escrow wallet;

FIG. 6 illustrates another method embodiment related to the use of escrow wallet; and

FIG. 7 illustrates yet another method embodiment.

### DESCRIPTION OF EXAMPLE EMBODIMENTS

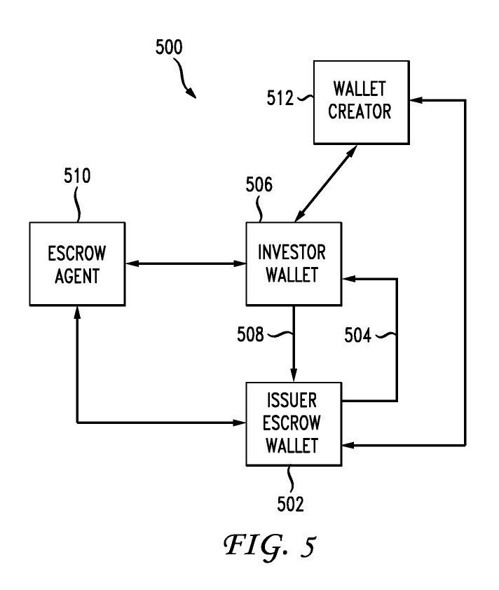

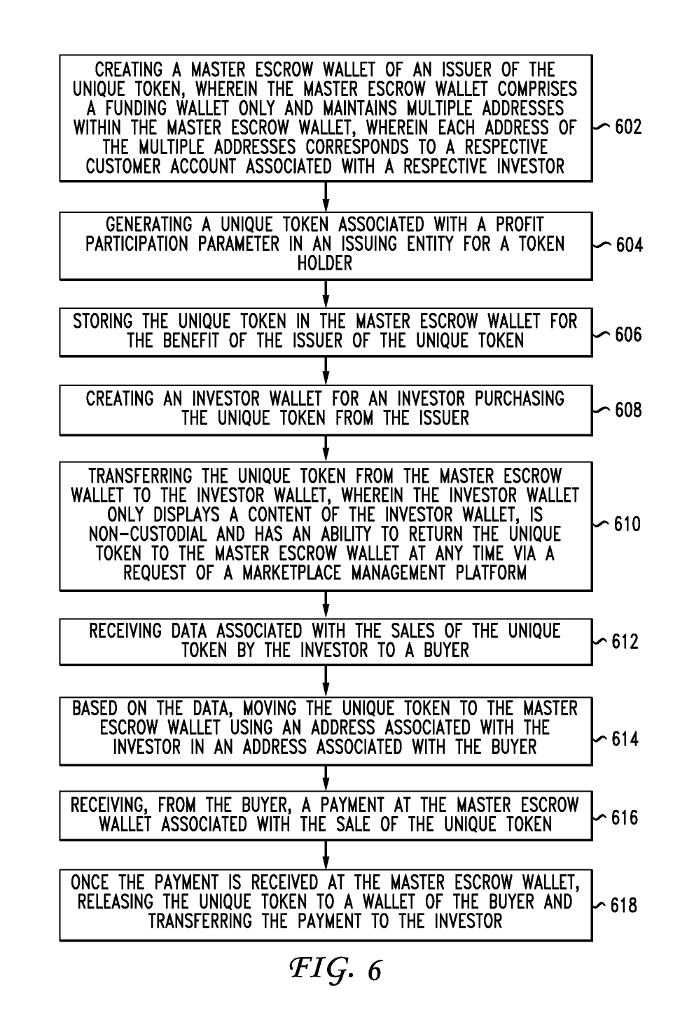

Various embodiments of the disclosure are discussed in detail below. While specific implementations are discussed, it should be understood that this is done for illustration purposes only. A person skilled in the relevant art will recognize that other components and configurations may be used without parting from the spirit and scope of the disclosure. There is a significant need for a framework which facilitates clear issuance of tokens as securities and in compliance with regulatory law and which has a technical component related to how tokens are issued and sold. There is further a need for the use of escrow wallets which can enable the holding of assets in a secure manner as part of transactions associated with issuing tokens as part of a token offering. The use of escrow wallets is provided primarily in FIGS. 5 and 6, with the associated discussion of these figures.

### OVERVIEW

Additional features and advantages of the disclosure will be set forth in the description which follows, and in part will be obvious from the description, or can be learned by practice of the herein disclosed principles. The features and advantages of the disclosure can be realized and obtained by means of the instruments and combinations particularly pointed out in the appended claims. These and other features of the disclosure will become more fully apparent from the following description and appended claims, or can be learned by the practice of the principles set forth herein.

The present disclosure provides an approach to utilizing escrow wallets, escrow closing wallets or transfer agents in connection with initial coin offerings. The introduction of an entity, such as a transfer agent, is provided herein that can perform similar tasks of safekeeping or holding assets with respect to blockchain-based tokens that are traded on alternative trading systems. A method includes creating a master escrow wallet of an issuer of the unique token, wherein the master escrow wallet includes a funding wallet only and maintains multiple addresses within the master escrow wallet. Each address of the multiple addresses corresponds to a respective customer account associated with a respective investor. The method includes generating a unique token associated with a profit participation parameter (such as an equity position) in an issuing entity for a token holder, storing the unique token in the master escrow wallet (or transfer agent) for the benefit of the issuer of the unique token, creating an investor escrow wallet for an investor purchasing the unique token from the issuer and transferring the unique token from the master escrow wallet to the investor escrow wallet. The investor escrow wallet only displays a content of the investor escrow wallet, is non-custodial and has an ability to return the unique token to the master escrow wallet at any time via a request of a marketplace management platform. The method further includes receiving data associated with the sales of the unique token by the investor to a buyer and, based on the data, moving the unique token to the master escrow wallet using an address associated with the investor or an address associated with the buyer. The method can also include receiving, from the buyer, a payment at the master escrow wallet associated with the sale of the unique token and, once the payment is received at the master escrow wallet, releasing the unique token to a wallet of the buyer and transferring the payment to the investor.

### DETAILED DESCRIPTION

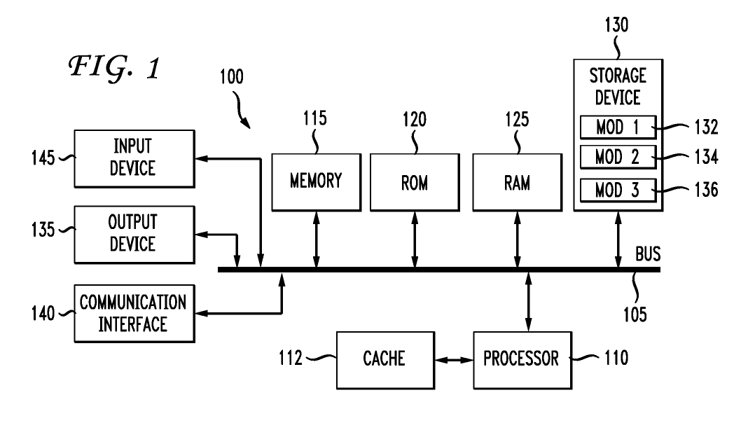

The present disclosure addresses the issues raised above and focuses the present claims on the use of escrow wallets. The disclosure provides several example implementations of the concepts disclosed herein. First, a general example system shall be disclosed in FIG. 1, which can provide some basic hardware components making up a server, node, or other computer system. Next, various approaches to providing token offerings and smart contracts are discussed to provide further context for the application of escrow wallets as disclosed herein.

FIG. 1 illustrates a computing system architecture 100 wherein the components of the system are in electrical communication with each other using a connector 105. Exemplary system 100 includes a processing unit (CPU or processor) 110 and a system connector 105 that couple various system components including the system memory 115, such as read only memory (ROM) 120 and random access memory (RAM) 125, to the processor 110. The system 100 can include a cache 112 of high-speed memory connected directly with, in close proximity to, or integrated as part of the processor 110. The system 100 can copy data from the memory 115 and/or a storage device 130 to the cache 112 for quick access by the processor 110. In this way, the cache 112 can provide a performance boost that avoids processor 110 delays while waiting for data. These and other modules/services can control or be configured to control the processor 110 to perform various actions. Other system memory 115 may be available for use as well. The memory 115 can include multiple different types of memory with different performance characteristics. The processor 110 can include any general purpose processor and a hardware module or software module/service, such as MOD 1 132, MOD 2 134, and MOD 3 136 stored in the storage device 130, configured to control the processor 110 as well as a special-purpose processor where software instructions are incorporated into the actual processor design. The processor 110 may essentially be a completely self-contained computing system, containing multiple cores or processors, a bus (connector), memory controller, cache, etc. When implemented as a multi-core processor, the processor 110 may be symmetric or asymmetric.

To enable user interaction with the computing device 100, an input device 145 can represent any number of input mechanisms, such as a microphone for speech, a touch-sensitive screen for gesture or graphical input, keyboard, mouse, motion input, speech, and so forth. An output device 135 can also be one or more of a number of output mechanisms known to those of skill in the art. In some instances, multimodal systems can enable a user to provide multiple types of input to communicate with the computing device 100. A communications interface 140 can generally govern and manage the user input and system output. The system 100 is not restricted to operating on any particular hardware arrangement and therefore the basic features here may easily be substituted for improved hardware or firmware arrangements as they are developed.

The storage device 130 may be a non-volatile memory, such as a hard disk or other type of computer readable media which can store data and that is accessible by a computer. Examples of such media include, without limitation, magnetic cassettes, flash memory cards, solid state memory devices, digital versatile disks, cartridges, random access memories (RAMs) 125, read only memory (ROM) 120, and hybrids thereof.

The storage device 130 can include software modules 132, 134, 136 for controlling the processor 110. Other hardware or software modules/services are contemplated. The storage device 130 can be connected to the system connector 105. In one aspect, a hardware module that performs a particular function can include a software component stored in a computer-readable medium in connection with the necessary hardware components, such as the processor 110, connector 105, display 135, and so forth, to carry out the function.

The hardware components described above can be implemented locally for an entity performing the functions disclosed herein or could be implemented in a cloud-based infrastructure or a virtual environment. The particular computer implementation of the tokens and smart contracts described herein can be on any underlying platform.

Having introduced the basic system embodiment in FIG. 1, the disclosure turns to the other figures. Disclosed herein is a unique design for token offerings that provides clarity to investors as to what they are purchasing and includes embedded economic interests with tokens issued by an issuing entity such as a company. The token offerings are tied to and/or aligned with the issuing entity and fiduciary obligations and investor protections are provided in that the tokens fall under the regulatory structure for securities. The fiduciary obligations and investor protections are largely absent in the current marketplace. The tokens will initially embed at least one feature that will interact with a smart contract or be provided as policy data to a smart contract and can be customized and adjusted based on the issuer's desire which can lead to a blending and toggling of the variables that are embedded within the token. The initial features that are customizable and adjustable include a yield, a profit participation or revenue share, an equity position, and a reward or perk based incentive. Other features embedded within the token can be personalization data about the token holder (age, income, risk tolerance, job, hobbies, social media data, purchasing habits, financial history, etc.). The following disclosure will cover various aspects of these features and how the tokens operate in connection with the smart contract to implement the yield, revenue share, equity, profit participation, perk based incentives, and/or other value added components.

Smart contracts help to exchange money, property, shares, or anything of value in a transparent, conflict-free way while avoiding the services of a middleman. Smart contracts can be compared in terms of technology to a vending machine. Ordinarily, a client would go to a lawyer or a notary, pay them, and wait while someone retrieves a requested document. With smart contracts, the user simply drops a bitcoin into the vending machine (i.e. ledger), and the escrow, driver's license, or other item drops into their account. More so, smart contracts not only define the rules and penalties around an agreement in the same way that a traditional contract does, but also automatically enforce those obligations. For example, an option contract between parties can be written as code into the blockchain. Individuals involved in the agreement can be anonymous but the contract is the public ledger. A triggering event, such as an expiration date or a strike price being reached, may occur and the contract will automatically execute itself according to the coded terms. Regulators can use the blockchain to understand the activity in the market while at the same time maintaining the privacy of the individual actor's positions.

The following is an example of a smart contract in operation. Suppose Fred rents an apartment from Sam. The parties can do this through the blockchain by paying in cryptocurrency. Fred gets a receipt which is held in the virtual contract. Sam gives Fred the digital entry key which comes to Fred by a specified date. If the key does not come on time, the blockchain releases a refund. If Sam sends the key before the rental date, the function holds it releasing both the fee and key to Sam and Fred, respectively, when the date arrives. The system works on the “If-Then” premise and is witnessed by hundreds of people, so one can expect a faultless delivery. If Sam gives Fred the key, Sam is sure to be paid. If Fred sends a certain amount in bitcoins, Fred receives the key. The document is automatically canceled after the time, and the code cannot be interfered with by either of Sam or Fred without the other knowing since all participants are simultaneously alerted. People can use smart contracts for all sorts of situations including, without limitation, financial derivatives, insurance premiums, breach contracts, property law, credit enforcement, financial services, legal processes and crowdfunding agreements.

The following is example code for creating a digital token that is compatible with the Ethereum wallet. This is of course just an example and not meant to be exclusive.

pragma solidity;
interface tokenRecipient { function receiveApproval(address _from, uint256 _value, address
_token, bytes _extraData) external; }
contract TokenERC20 {

```
// Public variables of the token
string public name;
string public symbol;
uint8 public decimals = 18;
// 18 decimals is the strongly suggested default, avoid changing it
uint256 public totalSupply;
// This creates an array with all balances
mapping (address => uint256) public balanceOf;
mapping (address => mapping (address => uint256)) public allowance;
// This generates a public event on the blockchain that will notify clients
event Transfer(address indexed from, address indexed to, uint256 value);
// This notifies clients about the amount burnt
event Burn(address indexed from, uint256 value);
/**
  * Constructor function
  *
  * Initializes contract with initial supply tokens to the creator of the contract
  */
function TokenERC20(
```

uint256 initialSupply,
string tokenName,
string tokenSymbol

) public {

totalSupply = initialSupply * 10 ** uint256(decimals); // Update total supply with the

decimal amount

| | |
|---|---|
| balanceOf[msg.sender] = totalSupply; | // Give the creator all initial tokens |

| | |
|---|---|
| name = tokenName; | // Set the name for display purposes |
| symbol = tokenSymbol; | // Set the symbol for display purposes |

```
}
/**
  * Internal transfer, only can be called by this contract
  */
function _transfer(address _from, address _to, uint _value) internal {
```

// Prevent transfer to 0x0 address. Use burn( ) instead
require(_to != 0x0);
// Check if the sender has enough
require(balanceOf[_from] >= _value);
// Check for overflows
require(balanceOf[_to] + _value >= balanceOf[_to]);
// Save this for an assertion in the future
uint previousBalances = balanceOf[_from] + balanceOf[_to];
// Subtract from the sender
balanceOf[_from] −= _value;
// Add the same to the recipient
balanceOf[_to] += _value;
emit Transfer(_from, _to, _value);
// Asserts are used to use static analysis to find bugs in your code. They should never fail
assert(balanceOf[_from] + balanceOf[_to] == previousBalances);

```
}
/**
  * Transfer tokens
  *
  * Send ‘_value‘ tokens to ‘_to‘ from your account
  *
  * @param _to The address of the recipient
  * @param _value the amount to send
  */
function transfer(address _to, uint256 _value) public {
```

_transfer(msg.sender, _to, _value);

```
}
/**
  * Transfer tokens from other address
  *
  * Send ‘_value‘ tokens to ‘_to‘ on behalf of ‘_from‘
  *
  * @param _from The address of the sender
  * @param _to The address of the recipient
  * @param _value the amount to send
  */
function transferFrom(address _from, address _to, uint256 _value) public returns (bool
```

success) {

| | |
|---|---|
| require(_value <= allowance[_from][msg.sender]); | // Check allowance |

allowance[_from][msg.sender] −= _value;
_transfer(_from, _to, _value);
return true;

```
}
/**
  * Set allowance for other address
  *
  * Allows ‘_spender‘ to spend no more than ‘_value‘ tokens on your behalf
  *
  * @param _spender The address authorized to spend
  * @param _value the max amount they can spend
  */
function approve(address _spender, uint256 _value) public
```

returns (bool success) {
allowance[msg.sender][_spender] = _value;
return true;

```
}
/**
  * Set allowance for other address and notify
  *
  * Allows ‘_spender‘ to spend no more than ‘_value‘ tokens on your behalf, and then ping the
```

contract about it

```
  *
  * @param _spender The address authorized to spend
  * @param _value the max amount they can spend
  * @param _extraData some extra information to send to the approved contract
  */
function approveAndCall(address _spender, uint256 _value, bytes _extraData)
```

public
returns (bool success) {
tokenRecipient spender = tokenRecipient(_spender);
if (approve(_spender, _value)) {

spender.receiveApproval(msg.sender, _value, this, _extraData);
return true;

}

```
}
/**
  * Destroy tokens
  *
  * Remove ‘_value‘ tokens from the system irreversibly
  *
  * @param _value the amount of money to burn
  */
function burn(uint256 _value) public returns (bool success) {
```

| | |
|---|---|
| require(balanceOf[msg.sender] >= _value); | // Check if the sender has enough |

| | |
|---|---|
| balanceOf[msg.sender] −= _value; | // Subtract from the sender |

| | |
|---|---|
| totalSupply −= _value; | // Updates totalSupply |

emit Burn(msg.sender, _value);
return true;

```
}
/**
  * Destroy tokens from other account
  *
  * Remove ‘_value‘ tokens from the system irreversibly on behalf of ‘_from‘.
  *
  * @param _from the address of the sender
  * @param _value the amount of money to burn
  */
function burnFrom(address _from, uint256 _value) public returns (bool success) {
```

| | |
|---|---|
| require(balanceOf[_from] >= _value); | // Check if the targeted balance is enough |

| | |
|---|---|
| require(_value <= allowance[_from][msg.sender]); | // Check allowance |

| | |
|---|---|
| balanceOf[_from] −= _value; | // Subtract from the targeted balance |

| | |
|---|---|
| allowance[_from][msg.sender] −= _value; | // Subtract from the sender's allowance |

| | |
|---|---|
| totalSupply −= _value; | // Update totalSupply |

emit Burn(_from, _value);
return true;

}

}

Bitcoin was essentially the first cryptocurrency to support basic smart contracts in the sense that the network can transfer value from one person to another. The network of nodes will only validate transactions if certain conditions are met. While Bitcoin is limited to the currency use case, Ethereum improves upon Bitcoin's more restrictive language (a scripting language of a hundred or so scripts) and replaces it with a language that allows developers to write their own programs. Ethereum allows developers to program their own smart contracts, or “autonomous agents”. The language is “Turing-complete”, meaning it supports a broader set of computational instructions. Smart contracts can function as “multi-signature” accounts, so that funds are spent or actions may occur only when a required percentage of people agree, manage agreements between users, say, if one buys insurance from the other, provide utility to other contracts (similar to how a software library works) and/or store information about an application, such as domain registration information or membership records.

Smart contracts are likely to need assistance from other smart contracts. When someone places a simple bet on the temperature on a hot summer day, for example, it might trigger a. sequence of contracts that are related. One contract would use outside data to determine the weather, and another contract could settle the bet based on the information it received from the first contract when the conditions are met. Running each contract requires Ether transactions fees, which depend on the amount of computational power required. Ethereum runs smart contract code when a user or another contract sends it a message with enough transaction fees. The Ethereum Virtual Machine then executes smart contracts in “bytecode”, or a series of ones and zeroes that can be read and interpreted by the network. While Ethereum is mentioned, any platform can be used to host the smart contracts disclosed herein.

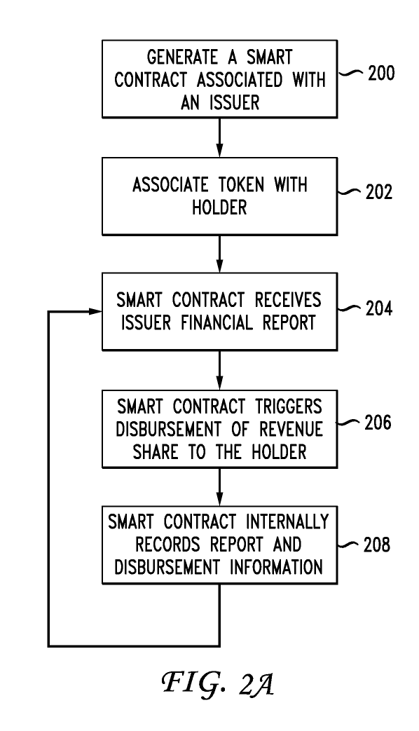

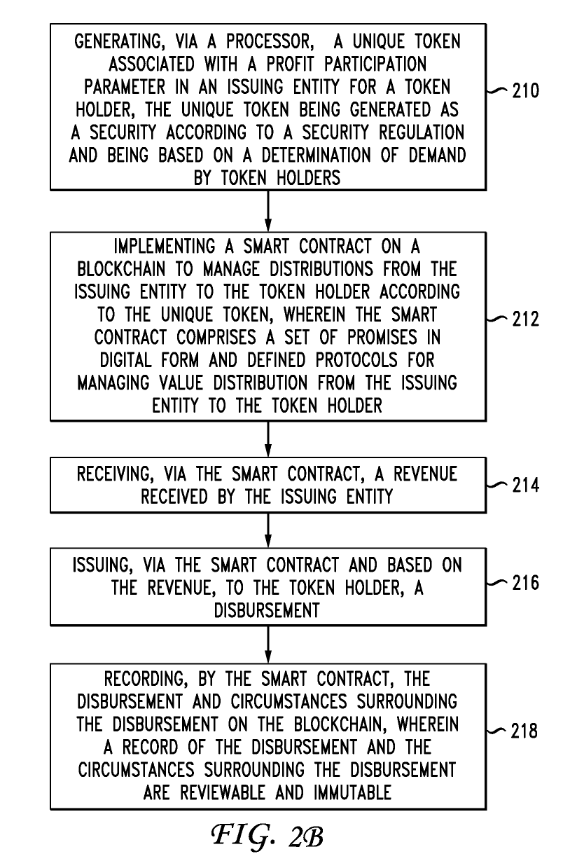

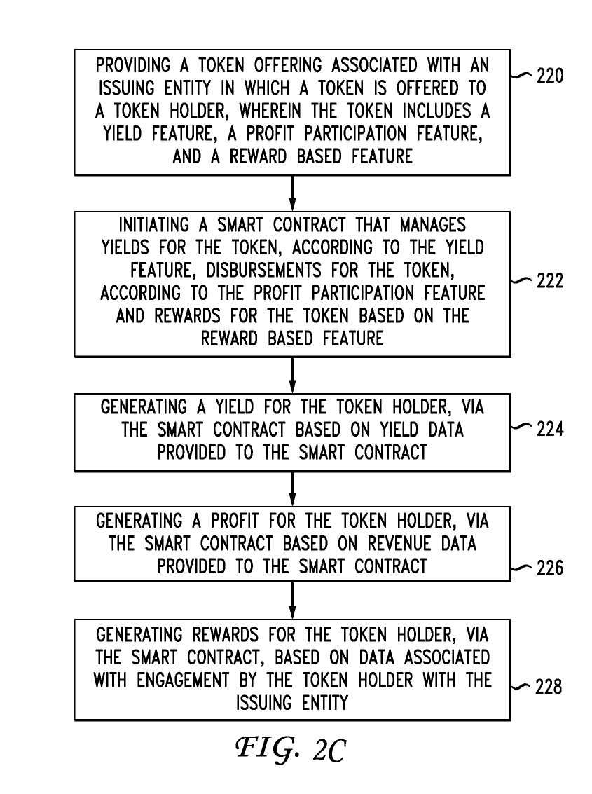

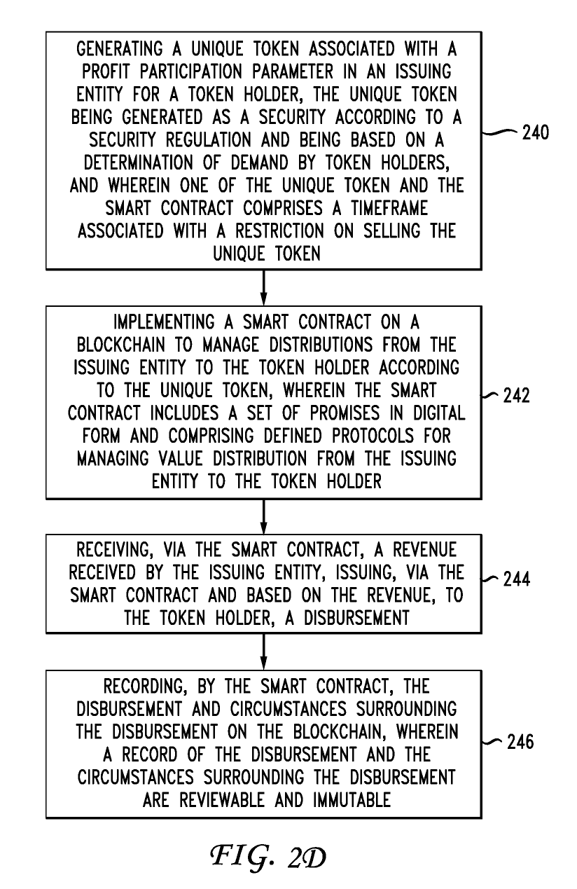

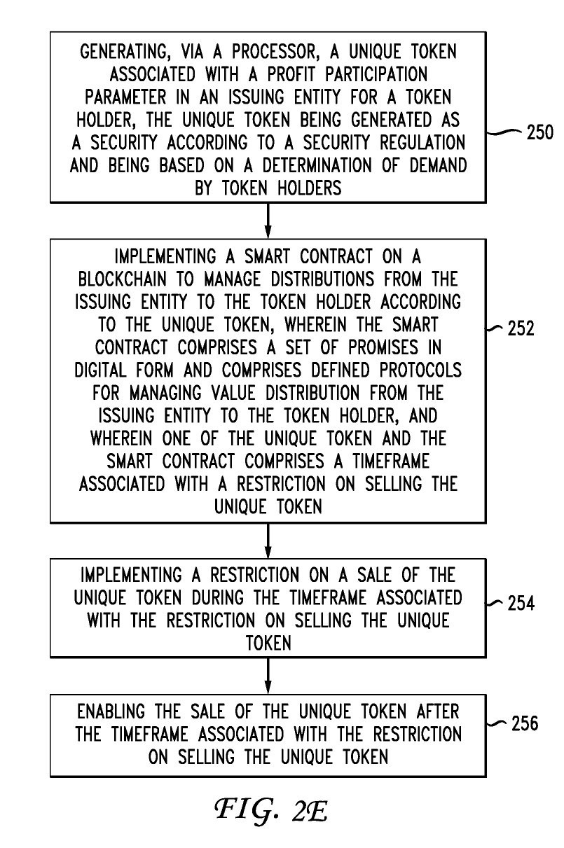

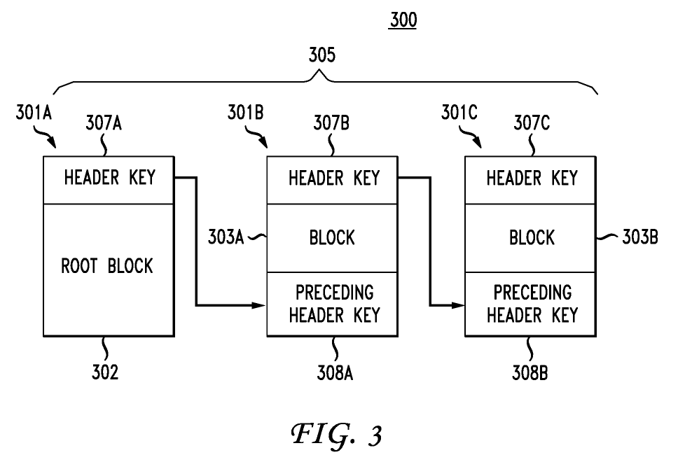

FIG. 2A illustrates a method embodiment. The method includes generating a token (step 200), which may be associated with an issuer. The token can be generated as part of a blockchain (such as the blockchain 300 described below in the discussion of FIG. 3) and issued or recorded onto the blockchain. The token may also be associated with programmable logic enabling both one-time and regularly repeated routines to be performed in association with the respective token. The token can also be related to a tokenized asset offering (TAO) or a security token offering (STO).

Once the token has been generated, the method includes associating the token with a holder (step 202). The token can be associated with the holder in multiple ways which will be apparent to a person of ordinary skill in the art and other manners yet to be seen. One non-limiting example of such an association is to store the token in a wallet including an address (not depicted). A wallet can include one or more private keys enabling users to access it. A wallet may also provide an address enabling other parties to direct various digital items to it such as more tokens associated with the issuer, third party tokens or coins associated with a different issuer or altogether different token architecture, or any other of multitude of digital items or digitally described items which will be apparent to a person having ordinary skill in the art.

In the example method of FIG. 2A, once a token has been associated with a holder (step 202), the associated programmable logic discussed above then enables a smart contract to receive financial information in the form of a report from the issuer (step 204). The financial information can include, for example, revenue data of the company, and/or any other information such as historical data, founder data, product/services data, debt data, newsletters, new reports about the company, and so forth. The financial information can be retrieved by the smart contract from any number of different sources including, without limitation, an issuer database/API, a third party reporting agency, an aggregator, an Oracle, input by an authorized user, social media data, or any other number of sources which will be apparent to a person having ordinary skill in the art. The programmable logic can be stored with the smart contract itself or can be stored at a separate location and be associated with one or more tokens under the purview of the smart contract. The smart contract can initiate a request for the financial report or the smart contract can receive a push update from an external reporter.

In one aspect, any, no, or all characteristics of the tokens and/or smart contract may be alterable. For example, due to the nature of the blockchain and trusted transactions being stored and available on the blockchain, the structure of the tokens in the processes that are carried out by the smart contract are immutable and do not change. Once the tokens are issued with the particular characteristics, and once the smart contract is initiated to carry out its instructions with respect to the parameters associated with the tokens and the performance of the issuing entity, the instructions should be set and unchangeable.

In another aspect, there could be various parameters that are capable of being altered within the system. For example, tokens can embed parameters such as one or more of an expected yield, a reward, a distribution, a characteristic, and so forth. The performance and recordation component associated with such parameters is then carried out by the smart contract. For example, the smart contract may process distributions and report on the payment associated with one of the parameters of the token. In one aspect, under very limited circumstances, the instructions could be altered, such as via biometric multiple level authorization by both parties.

In one example, one part of this overall system can be alterable by an entity, such as the issuing entity, that is able to modify the embedded parameters associated with one or more of an expected yield, equity position, reward, distribution, and so forth. For example, there may be an unexpected event such as a merger or an acquisition of another company by the issuing entity, which would cause a modification of the expected yield associated with a token. The parameters, such as an extra yield or dividend, could be modified or altered by changing the associated parameter in the token, which then gets input to the smart contract via reporting or associating of the smart contract with the token. The smart contract could also be altered in this regard.

As noted, the parameters of a token may be dynamic and/or alterable by an entity. The system can be built to include the ability of an issuing entity, or any other entity, to be able to modify those parameters while maintaining the structure of the smart contract with respect to managing distributions, reporting, recording and verifying that payment transactions associated with the tokens are immutable and verifiable. In another aspect, a token holder might have the ability to alter parameters associated with the token such that adjustments could be made for their own tax planning, estate planning, inheritance, and so forth. Thus, part of the concepts disclosed herein relates to a partial alterability of characteristics of the system after tokens are issued and the functionality of the smart contract is initiated. Such alterations or modification can be made to one or more of the tokens and the smart contract itself. In one aspect, where risk has potentially changed based on some event, a token holder could pay additional money (in any currency/cryptocurrency/other value) to have a parameter associated with the token altered, such as the distribution timing or amount. A graphical or other type of user interface could be provided to enable such interactions to take place.

Furthermore, in another aspect, all components of this overall system could also be alterable. Under certain circumstances, a process carried out by the smart contract could also be altered after its initiation. For example, entities that provide revenue data, calculations on how to disperse yields or dividends or rewards, mechanisms of recording transactions, mechanisms of verifying transactions, and so forth could also be altered by one or more entities.

In another aspect, a regulatory agency may change rules on how digital assets, tokens, etc. are regulated. The smart contract could be in communication with regulatory agency servers or services such that any change that is promulgated by a regulatory agency is automatically updated by or in the smart contract. For example, restrictions on how long to hold the asset, foreign owner restrictions, restrictions on or definitions of accredited buyers, insider trading rules, etc., can be modified by or in the smart contract in view of changes by regulating agencies. An “Oracle” or similar data feed distribution system could provide a trusted data feed about regulatory agency changes. In this regard, this aspect of the disclosure includes all of the steps and operations that may be implemented in terms of transmitting data receiving data, updating protocols and so forth. The embodiments related to these processes can be claimed from a standpoint of a regulatory agency updating a law or regulation and then promulgating that update via transmission of regulatory information out to a smart contract or smart contracts that are implementing policies as described herein for token offerings. The smart contract can then modify its processes according to the updated regulations. In another aspect, an embodiment might be claimed from the standpoint of the smart contract that receives updated regulations from a regulatory agency and then modifies its internal smart contract processes to accommodate or carry out future transactions based on the updated regulations. Data associated with or embedded within tokens can also be updated as well. Blockchain-based confirmations can be established to confirm to individuals following that particular smart contract that the proper updates have been implemented, applied and confirmed via the appropriate protocols for that blockchain.

In another aspect, the potential can exist for a dynamic parameter associated with the token to be altered after the initiation of the smart contract. There can be coordination and communication of such altered data or altered parameters to the smart contract which then adapts its performance according to the updated parameters. The smart contract could even engage in a confirmation process, via the blockchain, to confirm via external data, that the updated parameters are authorized for one or more tokens. The alteration of such parameters could be on a single token, a group of tokens, or all tokens. For example, one individual might have their tokens receive an increase to yield that differs from the originally embedded yield based on some action taken by the owner of the tokens or based on some other triggering event. A group of token owners may also have their tokens modified according to a characteristic of members of the group or some triggering event such as a change in regulation related to a timing of when a token can be sold, where it could be sold or to whom it could be sold. For example, an early adoption group of token purchasers can be given an increased yield based on some event. As another example, some token holders may be in a foreign jurisdiction and the regulations associated with foreign investors might change, which can trigger an alteration of the functions associated with that group of tokens. In another aspect, all token holders can have the parameters associated with their tokens altered or updated. In all these scenarios, the updated information can be provided to the smart contract in order for the realization of dividends or payouts according to the current information.

In the exemplary method embodiment, the smart contract can trigger a disbursement of revenue share to the holder (step 206) via the associated programmable logic. For example, the revenue share can be in the form of a fiat currency disbursement from a bank account of the issuer to a bank account of the holder or it can entail providing to the holder additional tokens associated with the issuer or a cryptocurrency payment or other value paid. The revenue share could also be something else like social media data or business intelligence data. The revenue share can also be third party digital currencies such as Bitcoin, Litecoin, Ether, or any other number of digital currencies that will be apparent to a person of ordinary skill in the art. The smart contract can trigger the disbursement by sending an authorized request to an entity holding the revenue sharing device. The request can include necessary holder information as an intended recipient, issuer information as an intended sender, and transaction information. Such transaction information may include, without limitation, the context of the disbursement such as issuer financial data, the programmable logic associated with the smart contract, and a history of transactions or any other information which will be apparent to a person having ordinary skill in the art.

In the method depicted by FIG. 2A, the smart contract can internally record important information from the financial report of the issuer as well as disbursement information (step 208). The information recorded from the issuer financial report can include total revenue, growth, and/or other information apparent to a person of skill in the art. The disbursement information can include type of disbursement (e.g., Bitcoin, US Dollars, additional issuer tokens, etc.), whether or not the disbursement was successful, and other information that will be apparent to a person of skill in the art.

Depending on the programming logic associated with the token, the method can be executed to completion once or can loop on a regular schedule. As depicted by FIG. 2A, the method can return to step 204 upon completion of step 208. Step 204 can occur on a yearly, monthly, variable, or other basis determined by the issuer and implemented in the programmable logic associated with the token. The occurrence rate of step 204 can be changed after issuance of the token or can be maintained as a static rate that is unalterable for the lifetime of the token. Step 204 can be set to reoccur regularly at issuance of the token and then later be adjusted to never occur again.

FIG. 2B illustrates another aspect of this disclosure related to disbursements and smart contracts. Specifically, FIG. 2B illustrates a computer-implemented method that includes generating, via a processor, a unique token associated with a profit participation parameter in an issuing entity for a token holder, the unique token being generated as a security according to a security regulation and being based on a determination of demand by token holders (step 210). The profit participation parameter can also refer to an equity share in the issuing entity. The method further includes implementing a smart contract on a blockchain to manage distributions from the issuing entity to the token holder according to the unique token, wherein the smart contract includes a set of promises in digital form and defined protocols for managing value distribution from the issuing entity to the token holder (step 212). The method also includes receiving, via the smart contract, a revenue received by the issuing entity (step 214) and issuing, via the smart contract and based on the revenue, to the token holder, a disbursement (step 216). Finally, the method includes recording, by the smart contract, the disbursement and circumstances surrounding the disbursement on the blockchain, wherein a record of the disbursement and the circumstances surrounding the disbursement are reviewable and immutable (step 218). The smart contract can receive data associated with or embedded within the token such as the policies or distribution structure, as well as other data from the token.

In one example, the instructions can be alterable by the issuing entity. The disbursement can include one or more additional tokens associated with the issuing entity or a cryptocurrency, a fiat currency, or another form of value. Additional tokens can be issued by a third-party. The instructions can be repeatedly executed at a time interval or triggered based on an internal or external event or data point. The size of the disbursement can be set by the issuing entity in whole or in part. For example, the disbursement value can be set in part by the issuing entity and its performance, revenue statistics, historical information, or future expectations, and in part by external data points such as market value demand, government regulation activity, and so forth. The time interval could also be set by the issuing entity.

In one aspect, the disbursement is issued in real-time. In other words, the smart contract is enabled to immediately act to allow for real-time distributions as it receives data that causes it to issue the disbursement. For example, as soon as the smart contract receives revenue data for the issuing entity, it can, dynamically and in real time, initiate a distribution to a token holder or token holders associated with the smart contract. At the same time, the smart contract can archive and create an audit trail of payment activity from the issuing entity to its token holders, thus providing fairness and alignment of interests across the ecosystem associated with the tokens. As noted above, the smart contract can manage disbursements to a single token holder or to multiple token holders.

FIG. 2C illustrates another method embodiment that includes providing a token offering associated with an issuing entity in which a token is offered to a token holder, wherein the token includes a yield feature, an equity share, a profit participation feature, and a reward based feature (step 220). The method further includes initiating a smart contract that manages yields for the token, according to the yield feature, disbursements for the token, according to the profit participation feature and rewards for the token based on the reward based feature (step 222). A yield is generated for the token holder, via the smart contract, based on yield data provided to the smart contract (step 224) and a profit is generated for the token holder, via the smart contract based on revenue data provided to the smart contract (step 226). The method further includes generating rewards for the token holder, via the smart contract, based on data associated with engagement by the token holder with the issuing entity (step 228).

The smart contract disclosed herein can also receive any data embedded within the token, such as personalized data for the token holder, or any of the yield, disbursement, and rewards data disclosed herein. The token data is also updatable by the token holder or the issuing entity, such as to change personalized data (such as to change a risk tolerance of the token holder or a change in risk to an expected disbursement), or to change yield data, disbursement data, etc. Any token data can be used to modify parameters or the performance of the smart contract to carry out the instructions of the smart contract.

FIGS. 2D and 2E provide several example methods related to building in a timing component or timing related restrictions on the sale of unique tokens as well as other aspects. A computer-implemented method is shown in FIG. 2D and includes generating a unique token associated with a profit participation parameter in an issuing entity for a token holder, the unique token being generated as a security according to a security regulation and being based on a determination of demand by token holders, and wherein one of the unique token and the smart contract includes a timeframe associated with a restriction on selling the unique token (240), implementing a smart contract on a blockchain to manage distributions from the issuing entity to the token holder according to the unique token, wherein the smart contract includes a set of promises in digital form and including defined protocols for managing value distribution from the issuing entity to the token holder (242), receiving, via the smart contract, a revenue by the issuing entity, issuing, via the smart contract and based on the revenue, to the token holder, a disbursement (244) and recording, by the smart contract, the disbursement and circumstances surrounding the disbursement on the blockchain, wherein a record of the disbursement and the circumstances surrounding the disbursement are reviewable and immutable (246).

The disbursement can be additional tokens issued by the original issuing entity, one or more tokens issued by one or more third party issuers, or a quantity of fiat currency. The processor-executable instructions may be executed multiple times at a time interval. The issuer may set the disbursement size or a time interval at which the processor-executable instructions are executed.

Other aspects of this disclosure can include a smart contract associated with tokens issued which are structured to provide a yield or a defined or stated return to the token holder. The yield can be an incentive to participate in the token sale. Another aspect can include providing further alignment between token holders and the issuing entity as consumers wherein stakeholders (token holders) become consumers of the organization they invest with and believe in. By so participating, token holders can receive additional rewards such as credits or discounts.

One or more aspects of the tokens and/or a smart contract can be alterable in whole or in part, and, in another aspect, would not be alterable. For example, the confirmation and recording performance of the smart contract may be unalterable so as to maintain the immutable and trusted nature of recording and confirming financial transactions. However, parameters associated with tokens provided by an issuing entity could be alterable after they are issued, such that, where circumstances warrant, a change in the yield, disbursement or reward structure, or a modification of a timing parameter could be modified on a single token, group of tokens, or all token basis. For example, is part of an operating agreement of the issuing entity, members, or directors of the issuing entity might have timing restrictions on the sale or purchase of tokens issued. These timing restrictions can be built into the smart contract or the tokens themselves as disclosed herein. However, if there's a modification in the operating agreement such that those timing parameters are changed, a mechanism could be built into the tokens, or smart contract such that with the proper authorization (fingerprint identification, facial recognition, password protection, multiparty authentication, and so forth) the timing parameters could be modified.

As noted above, additional regulatory requirements can also exist that relate to timing. Offerings can have a hold period of resale for a certain period amount of time according to certain regulation. The amount of time might be, for example, twelve months from the offering. The tokens also might also be offered only to accredited investors or investors having a required citizenship or who live in a certain geographic location. The timing restrictions could be based on inappropriate times of making a sale as well. For example, a sale of tokens by a founder may not be made possible on the Friday afternoon before an extended holiday weekend for the purpose of trying to avoid public extensive knowledge of the sale. Restrictions on a sale of tokens could occur in a timeframe around a certain company notice, such as bad news about an audit or some other event.

In the scenario of issuing a token offering, the qualification of the investor being an appropriately accredited investor can be built into the smart contract such that the smart contract validates the investor as accredited. The smart contract could confirm that the investor is a non-US person who is not required to be accredited or subject to the same restrictions. A third party service, such as an oracle that is a trusted source of the required data, can provide such data. Self reporting or some other functionality may also be built into the system to provide the credit worthiness of the investor or the buyer upon resale. Such functionality can be built into the smart contract and/or can be implemented via programming associated with each token.

The timeframe can depend upon one or more of a regulation governing a sale of the unique token and a regulatory status of the token holder. The method can further include, upon an attempt from a token buyer to purchase the unique token from the token holder within the timeframe associated with the restriction on selling the unique token, preventing, via one of the unique token and the smart contract, the token buyer from being able to buy the unique token.

The method can also include, upon an expiration of the timeframe associated with the restriction, enabling a token buyer to purchase the unique token from the token holder.

For example, the smart contract could receive an image or scan of a passport or a driver's license of the individual (potential purchaser or seller) and be able to confirm that the individual is a non-US resident. Access to banking records, previous investment history, asset holdings, credit worthiness data, and so forth can be provided through a data feed to enable the system to ascertain whether the user (buyer/seller) is an accredited investor. This information can also be stored within the token itself or within the smart contract or both. Part of the information could be stored in one location, with other information stored in the other location between the token itself and the smart contract. The data could also be normalized such that personal information about the buyer or seller may be normalized into simple data representing that they are or are not an accredited investor, or that they have the proper citizenship without revealing what their citizenship is. For example, the token can hold the normalized information that the user is an accredited investor when they buy a Reg D token.

As noted above, tokens can have a timeframe associated with them under which they are not allowed to be resold. A US accredited investor who buys a Reg D token cannot sell it for twelve months. A timer or a clock can be built-in to at least one or more of the token and the smart contract. Thus, a smart contract that is managing an ICO could simply not allow tokens held by accredited investors who are under the twelve month timeframe to be sold. A hold would be built into the process. This is essentially providing protection for the person on the other side of the transaction of the coin holder who might unknowingly buy or try to buy tokens that are not allowed to be resold. The clock can count down to eleven months, ten months, and so forth until the twelve month timeframe is over and the token can automatically be able to be resold.

There are a number of different mechanisms which can be implemented to enforce a timeframe restriction on the sale of the token. For example, upon the system receiving a request from a potential buyer to buy the token, the system could access data stored within the tokens sought to be purchased, which can include a built-in clock or timer, such that data can be ascertained from the token itself that because the timer is still running, the respective token cannot be sold. The smart contract can also operate a timer or maintain data identifying tokens which are still under timeframe restriction. Communication between the tokens and the smart contract can also occur. For example, a token can include a timer indicating a timeframe during which the token cannot be sold. Upon the completion of the timeframe, the token could provide notification to the smart contract that its timer has expired and that it is now available for sale. The smart contract, during the timeframe of restriction, could maintain a parameter associated with the respective token that the token cannot be sold. That parameter can be adjusted upon receiving the indication from the token that the restriction no longer applies.

With such timing mechanisms in place, if the investor tried to sell the token at six months, where the timeframe of restricted sales is twelve months, the system can block the sale. The system can also provide instructions, notifications, or any other communication as might be triggered by an attempt to sell such a token prior to the completion of the regulatory requirement. For example, the government official could be notified of the attempt of the sale as well as the token holder. Other notifications can be provided to the token holder indicating that the timeframe has now passed or notifications might be made public through communication channels that a respective token or group of tokens is now available for sale.

Different regulations can have different time frames. For example, a Reg S sale has a 40 day requirements. No clock is needed for a Reg A+ sale. In the context of the resale of such tokens, in some cases, a non-US citizen might purchase appropriately a token that a US resident could not buy. Thus, under a Reg D sale, if a non-US citizen wanted to purchase a token after six months, that sale might be allowed to proceed by the smart contract. However, the history of that sale can be stored within the blockchain, or within the token itself, or both, such that if those tokens were later sold to a US person, then the timer or clock returns back to the twelve month time period. Data regarding the history of the sale of a token can also be stored in parts between the token itself, and a smart contract or other blockchain database. Thus, in some cases, to retrieve the full history regarding the sales of a token, a requester might require accessing some data stored within the token itself and other data stored at a different location such as the smart contract or other blockchain database.

This approach can solve the problem for monitoring, archiving and auditing the trails of resale provisions. The smart contract can receive data about the seller, the buyer, the token, the timing element, and any other data, and process that data to allow a sale or place restrictions on the sale of tokens. Thus, with the timing procedures in place, an auditor would essentially have no work to do in that if a token was sold, by definition, the timing requirements would have been met as they are built into the token and/or smart contract.

Remedial processes can be implemented to overcome a hold on the sale as well, if possible. When the timeframe associated with the restriction on selling the unique token causes the smart contract to prevent a sale of the unique token to a token buyer based on a parameter, the method can include performing a remedial process to overcome an issue associated with the parameter and enabling the sale of the unique token to the token buyer.

For example, the data associated with the restriction can be analyzed or evaluated for a potential for remediation. If the potential buyer does not qualify as an accredited investor, but appears to be close to meeting the statutory requirements, a dialog could be initiated to indicate how close the potential buyer is to meeting the requirements and to see if any further information could be received regarding assets or income, or any other data required depending on what is needed, to see if further data can be retrieved to remedy the restriction. In other cases, a sliding scale approach could be utilized in which the status of an investor may not necessarily be a yes or no with respect to whether they are an accredited investor. For example, the qualifications associated with an accredited investor may be close enough that the buyer is allowed to buy a certain limited amount of the tokens, rather than an unlimited amount. For example, somebody who is a 75% accredited investor might be allowed to purchase 10,000 tokens and no more, where fully accredited investors will have no such limit. Such sliding scale variations can be built into one or more of the tokens themselves and the smart contract.

Furthermore, while some individuals may be limited based on their citizenship or geographic location, such restrictions may also have a sliding scale component in which a certain level of purchasing capability might be granted based on such factors.

In another aspect, the smart contract and have other capabilities, such as handling a right of first refusal in private company shares issued to employees, officers and directors. This is the type of provision where built into one or more of the tokens themselves or the smart contract itself, or both, when an attempt to resale private company shares is initiated outside of the right of first refusal provision, then the smart contract would block it that sale. Inasmuch as a parameter is set or data indicates that the entity who has the right of first refusal has not been offered the sale yet. Again, these types of events a restrictions can initiate a trigger which can notify one or more affected parties. For example, the party who owns the right of first refusal can receive a triggering notice that an attempt was made to sell the shares prior to their opportunity to buy. A user interface can be presented to the party with the right of first refusal which, when initiated, can present them the opportunity to bid or to purchase the tokens given the interest by the other party.

These kinds of provisions can relate to any kind of encumbrance or parameter which can affect the freedom of a token holder to be able to resell the token. The smart contract can have built into it procedures for handling any type of issue, whether it is a timing issue, whether it relates to a status of the buyer of the token, whether it relates to a third party who has contractual rights to that token prior to us resale, whether it has to do with the price restriction which might indicate that a resale of the token should be within a certain price range, or a volume restriction, such that circumstances require that only one thousand tokens or more can be sold in batches, and so forth. All of these kinds of restrictions and remedial actions, including timing restrictions with possible remedial actions, can be built into the functionality of the smart contract and/or data held within the tokens themselves.

The history of these attempted transactions can be recorded and reported as necessary. In some scenarios, the smart contract can notify the individual who it is attempting to sell the tokens of the respective restriction. There may be an opportunity if it is within the power of the seller to remedy the problem and actually complete the sale. For example, the smart contract could be built to let the seller know that the twelve month time period has not passed, but will be complete in two days. The smart contract could receive a confirmation from the user to re-commit the effort to sell the tokens when two days has passed and the regulatory restriction is listed. An automatic by order could also be generated which would immediately implement a buy action upon the completion of the time restriction. Thus, one aspect of this disclosure could be to both implement a timing restriction and to create a triggered action that can, in a frictionless and automated manner, implement the desired action when the restriction requirement is overcome. Thus, the remedial element in this regard does not necessarily mean that the restriction is immediately resolved and a purchase or sale action can occur but that a mechanism is generated to achieve the desired action when possible to do so.

In some scenarios, where there is a restriction on the sale of tokens, and other parties are involved, the smart contract could be utilized to establish a communication between the affected parties to discuss the matter. For example, if the right of first refusal is built into the smart contract, and a seller tries to sell the tokens without giving the holder of the right of first refusal the opportunity, then a conference call could potentially be scheduled, or a communication provided, or social networking set of communications delivered, such that the proper parties can be in communication to determine whether the sale should proceed or not. For example, if the owner of tokens attempts to sell the tokens that have a right of first refusal, the system could present a graphical interface which to the individual, with the right of first refusal in which they can interact with the graphical interface and either purchase the shares as is their right or affirmatively decline to purchase the shares, which would allow the attempted sale to proceed.

These and other types of interactions like these can be built into the smart contract and managed so as to if possible address the restriction to enable the sale to go through.

Another example method is shown in FIG. 2E and includes generating, via a processor, a unique token associated with a profit participation parameter in an issuing entity for a token holder, the unique token being generated as a security according to a security regulation and being based on a determination of demand by token holders (250), implementing a smart contract on a blockchain to manage distributions from the issuing entity to the token holder according to the unique token, wherein the smart contract includes a set of promises in digital form and includes defined protocols for managing value distribution from the issuing entity to the token holder, and wherein one of the unique token and the smart contract includes a timeframe associated with a restriction on selling the unique token (252), implementing a restriction on a sale of the unique token during the timeframe associated with the restriction on selling the unique token (254) and enabling the sale of the unique token after the timeframe associated with the restriction on selling the unique token (256).

Implementing the restriction on the sale during the timeframe associated with the restriction on selling the unique token and enabling the sale of the unique token after the timeframe associated with the restriction on selling the unique token can be implemented via a configuration of the unique token or via the defined protocols in the smart contract. The timeframe associated with a restriction can be dynamic and can be determined based on data received from an oracle identifying regulatory parameters. The timeframe associated with the restriction on selling the unique token can also be dynamic and based on one or more of a citizenship of a token buyer, parameters in operating agreement associated with the issuing company, a government regulation, a location of the token buyer or a status of the token buyer.

Upon an attempt, from a token buyer to purchase the unique token from the token holder within the timeframe associated with the restriction on selling the unique token, the method can include preventing, via one of the unique token and the smart contract, the token buyer from being able to buy the unique token. The method can also include receiving, at the smart contract, data about the token holder, a token buyer, characteristics associated with the unique token, and the timeframe associated with the restriction on selling the unique token and, based on the data, performing one or more of allowing a sale of unique token, placing restrictions on the sale of the unique token, modifying a restriction associated with the sale of the unique token, and/or implementing a new restriction on the sale of the unique token.

FIG. 3 depicts one embodiment of a token or smart contract 300 in the form of a blockchain 305. It is understood that any number of more blocks can be included in a blockchain and the depicted blockchain 305 only provides a non-limiting example of a blockchain having three blocks 301A, B, C.

An initial block 301A includes a root block 302 and a header key 307A. Generally, header keys, such as header keys 307A-C, can be a hash key used to verify the integrity of the contents of the preceding block. Here, header key 307A is generated by hashing the contents of root block 302. Any modification to the contents of root block 302 that is hashed will result in a different header value that will not match the value of header 307A.

Block 301B includes a preceding header key 308A. Preceding header key 308A is generated by hashing the value of header key 307A. Therefore, any alteration to header key 307A will, when hashed, result in a different value than that stored in preceding header key 308A and so reveal whether the header key 307A has been altered.

Similarly, preceding header key 308B is generated by hashing the value of header key 307B and any new block added to the chain will include a preceding header key generated by hashing, e.g., the header key 307C of block 301C. Guarantees against post hoc edits are given by this intertwining of the header keys, preceding header keys, and contents of each block.

Root block 302 can contain information such as issuer identity, holder identity, and programmable logic dictating, as a non-limiting example, rules for enabling steps 202-228 of FIGS. 2A-C. Blocks 303A and 303B of blockchain 305 may include disbursement information, such as disbursement information as recorded in step 218 of FIG. 2B. Blocks 303A and 303B may include sequential disbursement information, the information of 303A occurring before the information of 303B. As discussed above, in some embodiments, root block 302 can contain scheduling rules for receiving financial information from the issuer. Furthermore, blocks 303A and 303B can contain updates to rules stored in root block 305. Alternatively, each block, 302, 303A, 303B, etc. can each include programmable logic superseding that contained in previous blocks, if any. In this way, the token may keep up with changes to disbursement rules, financial report or disbursement timing, and changes to ruling regulatory law.

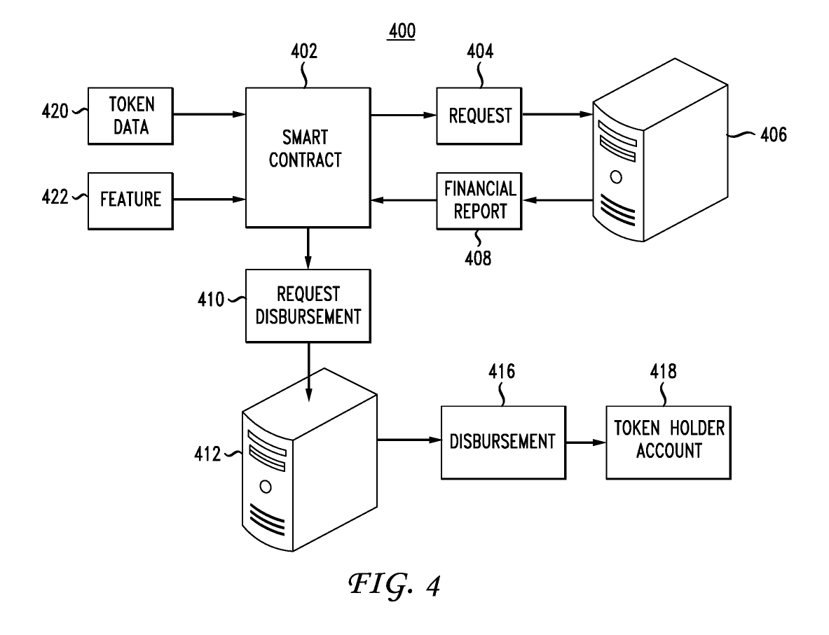

FIG. 4 depicts an embodiment of a possible architecture 400 implementing the methods described above. Architecture 400 is a non-limiting example embodiment and other embodiments will be apparent to a person having ordinary skill in the art. This embodiment illustrates a smart contract 402 and how it can receive data and carry out disbursement one or more of yields, profit sharing, or rewards that are associated with tokens issued by an issuing entity. Any token data, including personal profile data associated with the token holder, can be used to modify the performance of the smart contract.

For example, token data 420 is shown as providing information that is embedded within the token to the smart contract. The token can store or be structured in order to provide a defined or stated return that the token holder will receive as an incentive for participating in a token sale. The yield can be structured for a specific term, which can be determined by the issuing entity, to coincide with, among other things, a business plan, a cash flow, or a cash flow projection. The issuing entity can elect to create a reserved from the offering to ensure that the yield is paid to the investors for the stated term. The issuing entity can determine the yield based on global benchmarks, market demand, and token investor appetite. Any one or more of these factors can be included in the analysis. As an additional incentive to align the token holder's interest to the issuing entity, a profit participation or revenue share can also be built into the token 420. The profit participation can be programmed into the smart contract to create a transparent, trackable, defined, and immutable economic alignment of the success of the issuing entity with the token holders.

The token data 420 can provide the profit participation and revenue share data to the smart contract. Again, the profit participation parameters can be determined by the issuing entity, based on the determination of demand of token holders. These two initial variables that are embedded within the token create, in one aspect, the token structure as a security. The result of this structure is that the use of the token flows clearly within securities regulation and provides a framework for a clear fiduciary responsibility of the issuing entity to his token holders while affording the token holder investor protection under the Securities Act. One benefit of digitized securities in the form of a dynamic smart contract allows for real-time distributions, archiving, and audit trails of payment activities from the issuing entity to its token holders thus lending itself to fair play and alignment of interests across the ecosystem associated with token.

Another aspect which can be provided by implementing the concepts disclosed herein is rewards or perks-based incentives. These incentives can also be embedded within the token 420 and provided to or as part of the smart contract 402. As a result of such incentives, further alignment is achieved between token holders and the issuing entity, as consumers can become stakeholders (i.e., token holders) and stakeholders can become consumers of organizations they invest with and believe in. By creating additional incentives in the form of rewards and perks, token holders can become advocates to disseminate a message of the issuing entity to the marketplace. Such a process can increase a token holder's own engagement with the issuing entity products and services. In so doing, the token holder can receive additional rewards in the form of credits or discounts that can be used in exchange to purchase the products or services of the issuer. As token holders engage with an issuing entity and refer new customers, post to social media outlets such as Facebook, Instagram, Snapchat, and so forth, the concepts disclosed herein can enable them to receive defined points, credits or rewards from the issuing entity.

In one example, the issuer can assign ten points of credit to the token holder for posting something in regard to the issuing entity's product or services to Facebook. In another example, the token holder can receive five points of credit for uploading a picture to Instagram during the issuer's engagement. An infrastructure (server, communication modules, network-based data centers) can be developed to receive notification or data about the posting on a social media site and implement the credit for the token holder. In yet another example, centers of influence in the form of celebrities, athletes, or people or organizations with social media can be utilized to generate value for a token holder. For example, following can become a significant conduit for the issuer, while those token holders can build significant credits for utilizing services or products of the issuing entity. The activity of providing perks or reward incentives can be built into the smart contract and is fully transparent and transferable. Perks and reward incentives may be stored within the token holder's account or wallet 418, furthering the ready availability of accrued credits for use by the token holder, whether such use is in the issuer's own product or services or in exchange for goods and services of different organizations who may accept such rewards. Feature 422 represents any type of social media or rewards data that is provided to the smart contract 402. This can be publicly available data, or maybe data that is retrieved privately via a social networking site such as Facebook. It is presumed that the proper authorizations are obtained by the token holder for providing such data.

By issuing entities further aligning with other issuers in acceptance of one another's credits and tokens, a virtual circle of expanded networks of token holders can be created. The expanded network can enable engagement across the spectrum of affiliated issuers and create effective grassroots distributors from advocates of the issuing entities where aligned with their smart contract token holdings.

The smart contract 402 can include a blockchain as depicted in FIG. 3 and discussed above or can be an altogether different embodiment of the smart contract. In the context of the profit participation feature, the smart contract 402 can initiate a request 402 triggered by programmable logic associated with the smart contract 402. The programmable logic can be contained within smart contract 402 or can be stored elsewhere and have a reference to the smart contract 402. Regardless as to where the programmable logic is stored, the request 404 is transmitted to device 406.

Device 406 can be a server controlled by the issuer. In response to receiving a request 404, device 406 transmits a financial report 408 of the issuer to the smart contract 402. Upon receiving financial report 408, the smart contract 402 executes associated programmable logic. As depicted, the smart contract 402 can then transmit a disbursement request 410 to device 412. Device 412 can be a server controlled by the issuer or may be a server controlled by another entity such as a bank, third party digital currency storage, or any other entity as will be apparent to a person of ordinary skill in the art.

Device 412 initiates a disbursement 416 in response to receiving disbursement request 410. A disbursement 416 is transmitted to an account 418 associated with the token holder. As discussed above, the account 418 can be the token itself, a wallet address, a bank account, or any other holder account apparent to a person of ordinary skill in the art.

The uniquely structured benefits set forth herein yield profit participation and reward-based incentives, aside from creating differentiating economic benefits and incentives for token holders, and can create separate and distinct value and tradability of the token itself in a secondary marketplace as successive particular tokens, which can have a limited supply, garner future token or token holder appetite to engage with issuers who have alignment with their market participants and consumers. All aspects of this concept of buying and selling tokens as they are defined herein on a secondary market are considered as being disclosed herein. Steps to offer, accept an offer, purchase, exchange value, receive, transmit and so forth tokens on a secondary market are included as well as any hardware or compute-based devices and servers to implement a secondary market.

The standardization of token holders' economic interests and reward based incentives creates a best practice for token sales, investor protection, and fiduciary responsibility of issuers that are governed by securities practice, through licensed personnel, broker-dealers, exchanges, alternative trading systems, custodians, clearing, registrar and transfer within the framework of blockchain in order to facilitate the true democratization of capital formation while opening and affording investors who previously did not have access to these unique and compelling investment opportunities.

Further example token structures can be presented as follows. A structure could be categorized as a first structure which may have a luxury type component associated with it. Under this model, the issuing entity could pay a stable yield amount, and pay a profit participation component associated with the token. The reward component can be structured to provide an amount of credit that is preloaded to the token, which allows the token holder to utilize, for example, services for a luxury rental inventory or to reduce the cost of that vehicle or service as a mechanism to increase engagement of the token holder for the issuer's services. The token holder would receive varying points or credits back to the token via the smart contract for utilizing social media, promotions, or referrals. For example, in an effort to promote the brand and lifestyle, if the token holder published a Snapchat story with the vehicle or yacht, they would earn 10 points credit to the token to apply to future rentals as a discount or a credit. If they post an experience to Facebook, they would receive 15 points. For hash tagging or referring a friend over a social media network, they would receive 20 points. The integration of the reward program towards the future utilization of services would reward points to the users and encourage further engagement and loyalty of the consumers/token holders to the service provider/issuer. This approach has the additional benefit of profit participation in the token also gives the token holder the incentive to make referrals and subsequently increase the revenue of the issuer because they have a sharing in the profit, based on the success of the company.

Another example structure could be a lottery or raffle structure. In this scenario, the issuing entity will pay a stable yield and will pay a profit component and a reward component that will uniquely allow the users to participate in ticket sales based upon specific geographies, which could entail states, countries, or regions that allow the token holder to participate as a reward, or referral in the lottery/raffle. The token holder could structure the raffle to be a 50/50 structure based on a fan base, affinity group, or diaspora community where they would be enabled to participate in receiving 10 credits for each referral-enabling them to purchase future raffle tickets for future credits. The token holder may receive 1000 credits for the establishment of a 50/50 raffle. Additionally, a token holder can receive rewards in the form of a small percentage of the winnings.

In one aspect, the system can enable a user to choose which structure they desire. For example, a luxury structure with the predetermined components with respect to yield, profit sharing, and rewards program or a lottery/raffle component with it structure of a particular yield, profit component and reward component.

In another aspect, the smart contract can be programmed to permit token holders to track and archive the amounts of rewards that are generated through online referrals that would take the form of points or tokens earned for the redemption of product for the issuer/manufacturer/distributor. For example, promoting a toy manufacturer via social media or referral network would earn a predetermined number of points as well as a token for the issuer's products, which would be aggregated in a smart contract. The aggregated rewards would then be able to be redeemed for products or a specific toy of the manufacturer.

In another aspect of this disclosure, an anti-money laundering (AML) processes may also be built into the issuance of tokens. Such a structure can include AML procedures to identify purchasers and sellers. Know your client (KYC) requirements may also relate to being accredited or qualified purchasers, which is another important feature by way of investor protections. In a regulation D 506(c) offering under general solicitation, for example, the issuer can advertise to anyone and any inbound investor has to be accredited. A retail investor may not be allowed to make the purchase of a token offering under regulation D. These types of identification requirements and data associated with being a qualified investor can be embedded within one or more of the tokens or the smart contract. A verification and validation process for investors may be executed to confirm that an investor meets all regulatory requirements. For example, a service could provide personalized verification data associated with a potential investor a token issuer or to a smart contract such that a particular token holder can be identified properly and qualified properly (e.g., does the inventors have enough income, net assets, experience, etc., to purchase the tokens?), and so forth, for regulation D offerings. The purchaser may provide access to a service or to their financial data such that an automatic access could be provided through an application programming interface (API), for instance, for analyzing their capabilities.

The smart contract can include programming or functionality that receives an initial identification of a potential purchaser of tokens in the offering, and accesses databases that are authorized by the potential investor to evaluate the credit worthiness or financial condition of the investor and returns a confirmation that the investor is accredited or not. The smart contract could access, through an API or other communication mechanism, the various entities holding the data (banks, mortgage companies, car dealerships, brokers, etc.) , which may be about, among other things, a home value, a bank account, investments, debt, historical financial data, and so forth for the investor to make the evaluation. The smart contract could also perform this function on a periodic basis as in some cases accreditation is to occur every 6 months. The tokens could also include parameters that tie the ongoing yield, dividend and/or rewards to the accreditation confirmation of the token holder. For example, the yield could go down or up if the smart contract, 6 months into the operation, identifies that the token holder is no longer accredited, some other event occurs which increases or decreases risk, and so forth.

Once the token is embedded with an accredited holder status, the smart contract may be subject to various resale regulations. For example, the token may be subject to a 12-month resale provision for tax purposes or other restrictions in the United States. If someone tries to transfer the token, a multisignature confirmation approach could be implemented through the smart contract that prevents the token holder from selling that token before the 1-year anniversary. Thus, regulations can be implemented through the smart contract in this manner. As noted above, updates to regulations can also be provided to the smart contract such that its processing of dividends, restrictions on sale, and so forth can be according to the current regulatory environment.

In the scenario of a Regulation S offering, the token can be embedded with a regulatory parameter, which allows a user to sell the token to a foreign investor after 40 days. If a US investor then later buys that token, the smart contract can cause it to return to a 12-month sale restriction.

The discussion above provides a number of examples of how different offerings with different regulatory structures can be baked into tokens to identify the type of offering associated with the token, which information can then be communicated to or also provided to a smart contract that is carrying out the lifecycle of the tokens and their return on investment provisions.

In another aspect, the token can be embedded with a provision that identifies the token as owned by an insider of the issuer. The identification can provide more detailed information about the insider or may be more generic. For example, if the token is owned by the CEO of the issuing entity, that information could be made available or embedded within the token. If the token holder is more of an affiliate of the issuing entity, and thus not in a key strategic position, that information could be provided as well. This information may be useful in terms of providing transparency when tokens are sold or when dividends rewards or yields are provided. This feature can be provided as an aspect of investor protection. Also, in the case of a potential purchaser of the issuing entity or of an individual token or a group of tokens, the purchaser can be aware that he or she is buying insider tokens. This information can also be dynamic where the status of a token holder may change. For example, an individual who buys tokens from the issuing entity may later join the company on their Board of Directors. Further, a CFO may hold tokens as an insider that then leave the company and no longer have an insider status. The parameters that may be embedded within individual tokens can include data that encompasses and reports the various ways of defining an insider for purposes of that token or issuing entity.

In addition, the parameters that provide dividends yields or rewards may also vary for insiders. The parameters may be enhanced or reduced for purposes of fairness or transparency where insider traders receive a specialized type of return. Using the smart contract, data can be provided with respect to, for example, different aspects of the return on investment for insiders versus average investors. All of the insider tokens can be tracked for their particular type of return relative to other investors. Therefore, if the insider tokens receive a higher yield or return, that information can be made transparent to all token holders or to those who have access to the data from the smart contract.

The smart contract can receive information about citizenship, geographic location, accredited characteristics, and so forth of sellers and buyers of tokens in a marketplace and cause or implement any regulatory changes in those transactions. Thus, restrictions on sale, modifications of yield, dividends, and/or rewards, changes in blockchain analyses and recordation requirements, and so forth, can be implemented by the smart contract as programmed and can be based on the various points of data that would be required to carry out regulatory requirements. All of the incoming and outgoing communications associated with the smart contract are included within this process.

The various external data sources would provide such information. For example, an investor in a foreign country as well as an investor in the United States could register with the service, which provides their confirmed status, of any type, which impacts how regulations are applied. Citizen status or changes to citizen status could be provided to the smart contract, which could cause a change in a regulatory requirement or function of the smart contract. Various embodiments disclosed herein can be claimed from the standpoint of the smart contract, the token holder, the issuer, or from the standpoint of the third party service providing accreditation or other data. Thus, any steps performed by any individual entity in this process can be described and claimed as part of this disclosure.

In one aspect, investors could have in a digital wallet stored locally, or at a network service, verified data that identifies and is trusted to properly identify their accreditation status, citizenship, geographic location, and so forth. In some offerings, self-identification of accreditation is not acceptable. Thus, in situations where the issuing entity has the obligation to confirm the accreditation status of a potential token holder, using an accreditation wallet or network-based confirmation service can enable the issuing entity to fulfill their requirements through the implementation of the smart contract which would communicate with and retrieve the authorization data from an accreditation digital wallet or an accreditation service. For example, the data can be retrieved through a specific API with a holder of an individual retirement account (IRA) or other investment accounts of the buyer, the buyer's mortgage holder, or any other entity that has relevant data associated with the buyer's accreditation status. The smart contract can be authorized to retrieve that data and confirm their status to fulfil the issuing entity's obligation.

A third party service can also perform this function. The accreditation for a buyer can also be stored on a blockchain and verified through a verification algorithm. Each periodic confirmation of their accreditation status can be added to the buyer's accreditation blockchain. This approach improves the process by resolving the inherent conflict of the situation where the issuer is required to confirm the accredited status of potential buyers. Further, issuers may not even really have the capability or expertise to properly accredit buyers. Using a digital wallet or third party verifier enables a token to be created and embedded as a “clean” token that is issued to a confirmed accredited buyer. Such a clean token is better configured for resale as well. Multi-signatory requirements can be required for any aspect of this disclosure to confirm data or for security purposes.

Another aspect of this disclosure relates to how to deal with mergers, acquisitions, or other changes in management of the issuing entity. For example, the tokens in this scenario are not on the capital table and would not be on the issuing entity's books as debt as the tokens are not a debt obligation. As there is a yield/reward/disbursement component to each token, there is a potential question of what happens to the token and its associated disbursement in response to a change of ownership event. A potential issue can exist if they stand to to lose their tokens in an acquisition. Several approaches can be implemented to enable the token holders to retain value or have value transferred in the context of a merger or acquisition. These solutions can protect the token holding investor when faced with such events.

One approach could simply be to enable the issuing entity and the purchasing entity to deal with the token holders in the event of a merger or acquisition. For example, if a company issues stock and raises $2M in normal regulated stock but then receives $10M from individuals who receive tokens, in the sale of that company, the regular stockholders would, in the standard fashion, receive capital gains income in process. However, the issuing entity or selling entity could arrange with the acquiring company to pay out whatever yields, dividends, or agreed-upon disbursements to the token holders as part of a merger process.

In another aspect, rules or parameters for dealing with a merger process may be embedded within the tokens. In such a scenario, information about the merger process, such as a signing of a letter of intent, or the initiation of merger discussions, the completion of due diligence, and the final funding event could be provided to the smart contract which could carry out the merger parameters that are embedded within the tokens or programmed within the contract. A merging process could also be programmed into the smart contract independent of any specific merge instructions embedded within the tokens.

In one aspect, the smart contract could be programmed to prepare for a merger event. Programming within the smart contract can be provided to the store historical information through the blockchain which can be utilized through a programmed algorithm to predict the future performance of the tokens. For example, if a token holder paid $1000 for the token and had received in dividends, yields and/or rewards a return of $1000 on their investment and there was an expected additional $2000 of income from that token over a period of several years, that information could be built into the smart contract such that a report could be provided which would provide information about an expected future income for that token holder. That data could be utilized to pay that token holder a certain amount in the event of the merger. The seller and the acquirer could agree that at the conclusion of the merger the smart contract report with respect to the token holders would be honored such that the token holders would receive compensation as part of the merger. The buying entity could also transfer the tokens to the new entity such that the same dividends/yields or rewards would continue to be paid.

The information associated with the token value as determined by the smart contract can be provided as a value to the parties and negotiated between the issuer and the acquirer. In one example, assume that on Jul. 1, 2017, data was provided to the smart contract that indicated that a merger had formally begun and that the merger was expected to take nine months. The smart contract could predict the performance of the tokens and the expected future value gains to the token holders, nine months from Jul. 1, 2017. In one example, assume that it is predicted that all of the token holders can expect on Apr. 1, 2018, that they will have an aggregated additional yield, dividend and/or rewards of $20M over a three year period. A report can be provided and utilized to enable the acquiring entity to make an offer or negotiate a buyout of the token holders. In one aspect, the purchasing entity may directly buy the interests of the token holders at which point the acquiring entity may become the token holder and receive, in the above scenario, the yield, dividends and/or rewards would be received by the new owner of the tokens. The purchasing entity could also then resell the tokens to new buyers. The original token holders may want to have their tokens transitioned to the new entity at full value or agree upon a discount to maintain the tokens in place. Of course the buyer and the token holders could also negotiate the sale of the tokens to the new buyer of the issuing entity. The report and prediction of the value of the tokens in the future from the smart contract could be provided to enable the value to be ascertained.

In another aspect, the issuing entity could place money in an account, a crypto currency or put some value at a location that is accessible by the smart contract such that if the sale event or merger event occurs, it could trigger a payment to the token holders. The trigger could occur before the merger, during the sale, or after the sale and the sale may be to fund the token holder payment account. The smart contract could be structured such that the payment would be paid to the token holders if they had not received a certain return on their investment. For example, if a token holder purchased $1000 worth of tokens and had only received $500 in dividends prior to a merger event, the issuing entity could be required to retain $600 such that as the merger event is reported to the smart contract, and if it is confirmed that it will occur or is occurring, that the token holder receives $600 from the account, which enables them to both receive their initial purchase price plus a profit. An amount of money in a holding account could also be required by the smart contract and could be adjustable as returns are provided to the token holders. For example, the amount in the account could be a dwindling amount as the token holders receive dividends such that as the token holders receive their initial payment plus a certain percentage of profit, say 20%, that the holding account then can be depleted. At this point, in one scenario, the token holders would be potentially open to losing their continued yield in the event of a merger but at the very least, the smart contract ensured that they received their initial investment plus some profit.

As is noted above, another aspect can include the smart contract creating a debt obligation for the issuing company. In the event of a merger, the smart contract could be programmed to produce a document which would represent the expected income to the token holders as an evaluation of the tokens held for the purposes of a buyout. The report can of course be modifiable or provided in the context of one year returns following the merger, two year returns, ten year returns, and so forth. Again, this report can be utilized for the purpose of providing and protecting the token holders in the merger event.

In yet another aspect, the tokens can be self-extinguishing or self-liquidating at the change in ownership event. One or more steps could potentially need to be taken before such self-extinguishing or self-liquidating event would occur and in connection with the merger event. In one aspect, once a smart contract receives the data that a merger has occurred or the type of change event has occurred, the smart contract may simply cease to operate and all of the associated tokens may self-extinguish. For example, if the merger data indicates that a merger will occur within the next three months with a certain probability, the smart contract could require a self-liquidating event where the issuing entity is required to pay the token holders a certain amount, which can be established based on the amount of capital returned, the amount of profit or rewards, as well as the predicted profit or rewards in the future, such that token holders receive at least their capital and a certain return from the issuing entity. In this scenario, the issuing entity may need to go into debt in order to pay the token holders, but that that would end up being in debt obligation on the record as part of the merger transition.

The protection features disclosed herein could be implemented as a toggle like feature within the smart contract that is essentially turned on when a merger event is initiated or on the horizon. Part of the obligations of the issuing entity to the token holders could be to provide such data with respect to mergers to the smart contract so that the protection provisions can be implemented in the event of a merger. A holding account or escrow account which stores some money or other value designed to protect token holders again could be utilized such that if merger discussions begin and the smart contract is not notified, or if a merger event occurs without the protections procedures implemented, that the value within the holding account could be retrieved and distributed to token holders in order to enable them to be made whole or receive an expected return. In other words, penalty provisions could be provided to urge the issuing entity to properly report merger discussion status to the smart contract.

By reporting the information associated with a merger, the smart contract could begin to implement protection features, such as increasing or enhancing the yield dividends or rewards. For example, if, at the initiation of merger discussions, it is expected that the merger negotiations will last one year, the smart contract could utilize the amount of capital returned, the amount of profit received, and the predicted return over that next year to make adjustments for the token holders. In one example, in order for token holders to receive a predetermined return on their investment, the smart contract might enhance all of the returns such that essentially a normal two year expectation of return would be provided to token holders within one year. In this scenario, when there tokens become extinguished as part of a merger event, the token holders are made whole without the need for the acquirer to deal with the tokens.

According to the agreed-upon parameters within the smart contract, the token holder protection provisions might also be dynamically adjusted as reports are provided throughout the merger negotiation process such that if the likelihood of a merger decreases and the process starts to break down, the return algorithms could potentially adjust returns back to their normal expected and programmed amount. The smart contract could also be implemented such that if accelerated returns are provided because of the expectation of a merger, but the merger falls through, the smart contract could reduce the returns over a period of time such that a year after the failed merger of events, the return algorithm has balanced out the returns for that period of time and is back onto a normal return schedule as though no merger discussions had occurred.

The information on the performance of the token could also be utilized to provide a value to that tokens which might be similar to a bondholder value. Depending on what the yield value is, that token might be sellable in a marketplace and the data held within the smart contract on its historical performance as well as his predicted performance can be used to establish that value.

In the issuer side of the smart contract, for example, with any of Reg A+, Reg D 506(b) or (c), Reg F, Reg C, or any other offerings, the regulatory requirements for those offerings on the issuer side can be built into the token offerings disclosed herein. The details of any regulatory statute that might apply are incorporated by reference and considered as part of this disclosure, as would be known by one of skill in the art. Any component of the requirements can be built into the tokens as well as the functioning of the smart contract. Similarly, any regulatory requirements on the buying entity, such as resale restrictions, foreign investor sale requirements, holding periods, accreditation levels, and so forth can also be built into the tokens.

Having discussed ICOs and the various concepts set forth above, the present disclosure addresses the issue of escrow wallets and introduces the concept of the creation of escrow wallets for third-party usage. There are two integration partners that have services that can be utilized as part of this new process. The technologies of these partners will be discussed as an example, but certainly this disclosure is not limited to any particular entities services, but rather involves the utilization of the new concepts disclosed herein. In other aspects, all of the functions can be implemented by a single platform.

In one example an entity can be created or partnered with that operates as an SEC approved transfer and escrow agent. Such an entity would provide full-service brick-and-mortar transfer agent services a range of software solutions to provide the exact stock transfer service for entities. For example, a transfer agent can provide services to issuers of privately and publicly traded stock with respect to new issuances of paper or book entry certificates, stock transfers, such as custodial/sale transfers, retirement transfers, conversion transfers, maintenance of shareholder registration, full digital storage of transaction records, dividend processing and distribution records, balance management and authorized shares enforcement, replacement of law stock certificates, corporate actions, such as name change, stock splits, mergers, mass conversions and retirements, DWAC (deposit, withdrawal at custodian) & DRS (direct registration system) services, accessible and transparency proxy and mailing services.

As transfer and escrow agent, such an entity can utilize a trustworthy a neutral third-party to make sure that any transaction is completed with integrity. Transactions can be between two shareholders or corporate activities such as raising capital. Security and privacy can be provided around any transaction. The transfer and escrow agent can make sure that stocks and funds are in good order and transferable and they can manage the disbursement as directed by agreements to the parties at the close of the transaction.

A service or entity that can be created to assist carrying out the functions dislcosed herein can provide a simple and robust RESTful API and client SDK to integrate digital currency wallet into an application. The API and SDK can allow the management of multiple digital currencies and wallet, through a single unified interface. The SDK enables the creation of multi-signature wallets wallet balance and transaction listings, transaction creation and signing, transaction monitoring locations, secure you the user authentication, multiuser workflows for use in enterprise environments and policies and spending limits. The present disclosure utilizes an API for seamless crypto currency wallet creation. The present disclosure provides a new concept of creating wallets for third-party usage rather than first person usage. Then, utilizing an SEC registered escrow or transfer agent, issuers and investors wishing to transact can have the ability to create escrow wallets within a new environment that implements a marketplace for the issuance and secondary trading of digital assets through security tokens.

FIG. 5 illustrates an example initial coin offering which utilizes escrow wallets to enable a secondary marketplace transaction. A computer implemented marketplace management platform can implement all or part of the processes disclosed. The marketplace can work as shown in FIG.5 with the various components 500. An issue with escrow wallets 502 can be created by the marketplace management platform for the benefit of an ICO issuer. This can be a funding wallet only with the ability to create multiple addresses within the wallet, wherein each address is tied to a corresponding customer account on the platform. This process can create redundancy of reporting of transactions, as well as can enable a minimum or maximum offering structure. A purchaser purchases one or more tokens or crypocurrencies or any other digital asset from the issuer 504. The platform sends the tokens purchased to an investor escrow wallet 506. This can be a third-party wallet or a platform escrow enabled wallet. As noted above, entities can provide some services or functionality associated with the creation and use of these escrow wallets. For example, an SEC approved transfer and escrow agent can be utilized. A company can provide some of the services for the technical creation and functionality of the wallet. Together, such services can provide a platform with the ability to create wallets for third-party usage rather than for first person usage as was previously done.

With the investor escrow wallet 506, a secondary market transaction can occur such that the purchaser of the tokens that are stored in the investor escrow wallet 506 can then sell those tokens on a secondary marketplace. As part of the functionality of the secondary marketplace, all tokens are eligible to transact on the platform will have a master escrow wallet that facilitates the transfer. In this scenario, the original purchaser of the token becomes the seller in that secondary marketplace. The seller will create and transfer tokens to their third-party escrow wallet on the platform. The functionality of the wallet is that it allows the contents of the wallet to be displayed only in the sense that it is noncustodial as that term is used in financial transactions. However, the wallet does have the ability to return tokens to the original account at any time, via a request on the platform. This process allows for the instant validation of ownership and the ability to deliver the tokens to the appropriate address of soul. In one aspect, the wallet disclosed herein can act of the transfer agent registered with the SEC and can perform the functions described herein.

In one aspect, and escrow agent 510 can provide services such as actually creating the escrow enabled wallet on a marketplace platform, or creating the escrow enabled wallets on a separate platform with a structure that allows crypocurrencies to be held in the escrow wallets, and, such that the escrow agent 510 can ensure that the tokens are in good order and transferable and can perform functions such as disbursement as directed by an agreement to respective parties. The escrow agent 510 can provide such services to the investor escrow wallet 506 as well as the issuer escrow wallet 502.

In another aspect, a wallet creator 512 can also be a separate entity that can provide wallet creation services to create an investor escrow wallet 506 and or an issuer escrow wallet 502. This wallet creator 512 can be a separate entity that coordinates with a marketplace platform 500, or it can include functionality built into the platform as well.

Where separate entities such as a wallet creator 512 as well as an escrow agent or transfer agent 510 are providing functionality to a marketplace platform, this disclosure includes all requests, calls, responses, and communication of data or functionality between such a service provider and the platform.

When tokens are sold, they are instantly moved to the master escrow wallet using addresses that enable the identification of the purchaser and/or buyer or any other entity necessary. The buyer then can make a payment in bitcoin, Ethereum, crypto currency, or any other asset 508, to the master escrow wallet 502. The master escrow wallet then releases the tokens to the buyer and the payment is transferred. In one aspect, the various wallets disclosed herein can be implemented as smart contracts.

FIG. 6 illustrates an example method. A computer-implemented method includes creating, via a processor, a master escrow wallet of an issuer of the unique token, wherein the master escrow wallet includes a funding wallet only and maintains multiple addresses within the master escrow wallet, wherein each address of the multiple addresses corresponds to a respective customer account associated with a respective investor (602), generating, via a processor, a unique token associated with a profit participation parameter in an issuing entity for a token holder (604) and storing the unique token in the master escrow wallet for the benefit of the issuer of the unique token (606). The method includes creating an investor escrow wallet for an investor purchasing the unique token from the issuer (608), transferring the unique token from the master escrow wallet to the investor escrow wallet, wherein the investor escrow wallet only displays a content of the investor escrow wallet, is non-custodial and has an ability to return the unique token to the master escrow wallet at any time via a request of a marketplace management platform (610), receiving data associated with the sales of the unique token by the investor to a buyer (612), based on the data, moving the unique token to the master escrow wallet using an address associated with the investor in an address associated with the buyer (614), receiving, from the buyer, a payment at the master escrow wallet associated with the sale of the unique token (616) and, once the payment is received at the master escrow wallet, releasing the unique token to a wallet of the buyer and transferring the payment to the investor (618).

The method can include generating a buyer escrow wallet to receive the unique token after the sale of the unique token. The buyer escrow wallet can be temporary and only be created and used for the duration of the transaction, and thereafter destroyed or deleted, or can be made permanent. The method can further include receiving buyer funds at the buyer escrow wallet, which can then be used as the payment received at the master wallet. The master escrow wallet can be utilized to manage secondary token transactions for all unique tokens that are eligible to transact on the marketplace management platform.

In one aspect, the master escrow wallet and the investor escrow wallet are created within the marketplace management platform under an account of a separate escrow agent, wherein the separate escrow agent provides security and privacy associated with the sale of the unique token. The sale of the unique tokens can occur via an alternative trading system which implements a non-exchange trading venue. In one aspect, generating the investor escrow wallet occurs at a same time as the sale of the unique token or in connection with the sale of unique token. For example, at the initiation of a transaction on a secondary marketplace associate with a token, the necessary wallet or wallet can be created, which can be used to identify and store addresses associated with participants in the transaction. Thus, as a transaction is initiated, the dynamic creation of appropriate escrow wallets can occur, such that when the transaction is confirmed, or authorized, the necessary wallet can be in place to receive funds, transfer funds, receive a digital asset, transfer additional assets, or perform some other functionality. Upon confirmation and completion of the transaction, reporting data can be provided and the wallet can either be made dormant or deleted or some other action can be taken.

In one aspect, an escrow agent can create the investor escrow wallet within the marketplace management platform. Thus, where claims might be directed to only the functionality of the platform, the platform could receive the escrow wallet created by a third-party or through medications between entities, such as APIs, and SEC approved transfer and escrow agent can create the escrow wallets within the platform, or issuers and investors within the platform can create escrow wallets under an account of the separate escrow agent. This process can enable digital assets to be held in an escrow wallet while ensuring that the data held within the wallet and transactions associated with the wallet are in good order and transferable. The escrow agent can be used to then disperse funds or digital assets as directed by the agreement between the parties at the close of a transaction. Thus, releasing the unique token to a wallet of the buyer and transferring the payment to the investor can occur according to an agreement between the buyer and the investor and can be implemented either by the platform itself, or essentially utilizing escrow wallet on the platform but at least part of the functionality could be performed by the separate transfer and escrow agent working in coordination with the platform.

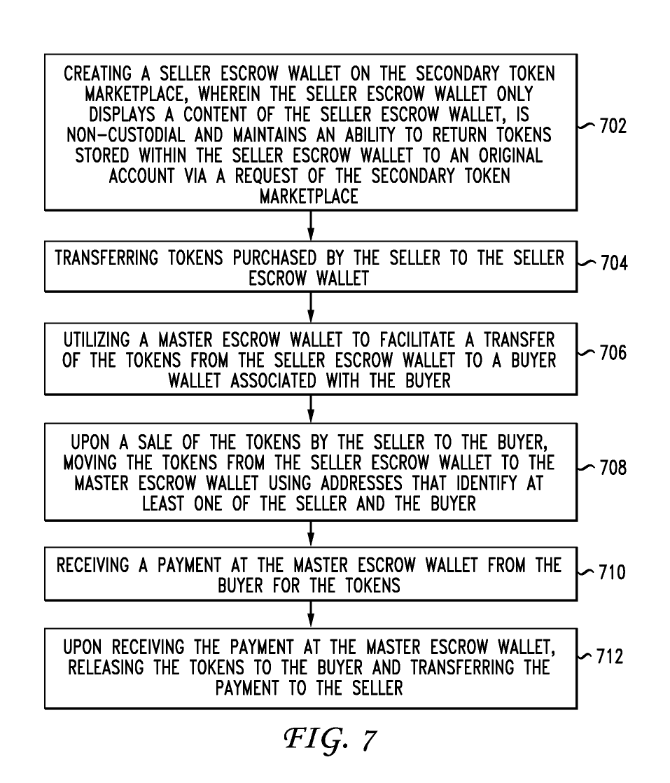

FIG. 7 illustrates another example method of operating a secondary token marketplace. The method in this example includes creating a seller escrow wallet on the secondary token marketplace, wherein the seller escrow wallet only displays a content of the seller escrow wallet, is non-custodial and maintains an ability to return tokens stored within the seller escrow wallet to an original account via a request of the secondary token marketplace (702), transferring tokens purchased by the seller to the seller escrow wallet (704), utilizing a master escrow wallet to facilitate a transfer of the tokens from the seller escrow wallet to a buyer wallet associated with the buyer (706), upon a sale of the tokens by the seller to the buyer, moving the tokens from the seller escrow wallet to the master escrow wallet using addresses that identify at least one of the seller and the buyer (708), receiving a payment at the master escrow wallet from the buyer for the tokens (710) and, upon receiving the payment at the master escrow wallet, releasing the tokens to the buyer and transferring the payment to the seller (712).

A system for operating a secondary token marketplace can include a processor and a computer-readable storage device storing instructions which, when executed by the processor, cause the processer to perform certain operations. The operations can include creating a seller escrow wallet on the secondary token marketplace, wherein the seller escrow wallet only displays a content of the seller escrow wallet, is non-custodial and maintains an ability to return tokens stored within the seller escrow wallet to an original account via a request of the secondary token marketplace, transferring tokens purchased by the seller to the seller escrow wallet, utilizing a master escrow wallet to facilitate a transfer of the tokens from the seller escrow wallet to a buyer wallet associated with the buyer, upon a sale of the tokens by the seller to the buyer, moving the tokens from the seller escrow wallet to the master escrow wallet using addresses that identify at least one of the seller and the buyer, receiving a payment at the master escrow wallet from the buyer for the tokens and, upon receiving the payment at the master escrow wallet, releasing the tokens to the buyer and transferring the payment to the seller.

In some embodiments, the computer-readable storage devices, mediums, and or memories can include a cable or wireless signal containing a bit stream and the like. However, when mentioned, non-transitory computer-readable storage media expressly exclude media such as energy, carrier signals, electromagnetic waves, and signals per se.

Methods according to the above-described examples can be implemented using computer-executable instructions that are stored or otherwise available from computer readable media. Such instructions can include, for example, instructions and data which cause or otherwise configure a general purpose computer, special purpose computer, or special purpose processing device to perform a certain function or group of functions. Portions of computer resources used can be accessible over a network. The computer executable instructions may be, for example, binaries, intermediate format instructions such as assembly language, firmware, or source code. Examples of computer-readable media that may be used to store instructions, information used, and/or information created during methods according to described examples include magnetic or optical disks, flash memory, USB devices provided with non-volatile memory, networked storage devices, and so on. Any token or structure/function disclosed herein can apply to a tokenized asset offering or a security token offering.

Devices implementing methods according to these disclosures can include hardware, firmware and/or software, and can take any of a variety of form factors. Typical examples of such form factors include laptops, smart phones, small form factor personal computers, personal digital assistants, rackmount devices, standalone devices, and so on. Functionality described herein also can be embodied in peripherals or add-in cards. Such functionality can also be implemented on a circuit board among different chips or different processes executing in a single device, by way of further example.

The instructions, media conveying such instructions, computing resources for executing them, and other structures for supporting such computing resources are means for providing the functions described in these disclosures.

Although a variety of examples and other information was used to explain aspects within the scope of the appended claims, no limitation of the claims should be implied based on particular features or arrangements in such examples, as one of ordinary skill would be able to use these examples to derive a wide variety of implementations. Further and although some subject matter may have been described in language specific to examples of structural features and/or method steps, it is to be understood that the subject matter defined in the appended claims is not necessarily limited to these described features or acts. For example, such functionality can be distributed differently or performed in components other than those identified herein. Rather, the described features and steps are disclosed as examples of components of systems and methods within the scope of the appended claims. Moreover, claim language reciting “at least one of” a set indicates that one member of the set or multiple members of the set satisfy the claim.

It should be understood that features or configurations herein with reference to one embodiment or example can be implemented in, or combined with, other embodiments or examples herein. That is, terms such as “embodiment,” “variation,” “aspect,” “example,” “configuration,” “implementation,” “case,” and any other terms which may connote an embodiment, as used herein to describe specific features of configurations, are not intended to limit any of the associated features or configurations to a specific or separate embodiment or embodiments, and should not be interpreted to suggest that such features or configurations cannot be combined with features or configurations described with reference to other embodiments, variations, aspects, examples, configurations, implementations, cases, and so forth. In other words, features described herein with reference to a specific example (e.g., embodiment, variation, aspect, configuration, implementation, case, etc.) can be combined with features described with reference to another example. Precisely, one of ordinary skill in the art will readily recognize that the various embodiments or examples described herein, and their associated features, can be combined with each other in any combination.

A phrase such as an “aspect” does not imply that such aspect is essential to the subject technology or that such aspect applies to all configurations of the subject technology. A disclosure relating to an aspect may apply to all configurations, or one or more configurations. A phrase such as an aspect may refer to one or more aspects and vice versa. A phrase such as a “configuration” does not imply that such configuration is essential to the subject technology or that such configuration applies to all configurations of the subject technology. A disclosure relating to a configuration may apply to all configurations, or one or more configurations. A phrase such as a configuration may refer to one or more configurations and vice versa. The word “exemplary” is used herein to mean “serving as an example or illustration.” Any aspect or design described herein as “exemplary” is not necessarily to be construed as preferred or advantageous over other aspects or designs.

Moreover, claim language reciting “at least one of” a set indicates the one member of the set or multiple members of the set satisfy the claim. For example, claim language reciting “at least one of A, B, and C” or “at least one of A, B, or C” means A alone, B alone, C alone, A and B together, A and C together, B and C together, or A, B, and C together.

What is claimed is:

1. A method of operating a secondary token marketplace, the method comprising:
creating a seller escrow wallet on the secondary token marketplace, wherein the seller escrow wallet displays a content of the seller escrow wallet, is non-custodial and maintains an ability to return tokens stored within the seller escrow wallet to an original account via a request;
transferring tokens purchased by a seller to the seller escrow wallet;
utilizing a master escrow wallet to facilitate a transfer of the tokens from the seller escrow wallet to a buyer wallet associated with a buyer;
upon a sale of the tokens by the seller to the buyer, moving the tokens from the seller escrow wallet to the master escrow wallet;
receiving a payment at the master escrow wallet from the buyer for the tokens; and
upon receiving the payment at the master escrow wallet, releasing the tokens to the buyer.

2. The method of claim 1, further comprising:
issuing the buyer a buyer escrow wallet to deposit funds associated with the payment and accept delivery of the tokens.

3. The method of claim 1, further comprising:
transferring the payment to the seller upon receiving the payment at the master escrow wallet.

4. The method of claim 1, wherein upon a sale of the tokens by the seller to the buyer, the method further comprises moving the tokens from the seller escrow wallet to the master escrow wallet using an address that identifies one of the seller or the buyer.

5. The method of claim 1, wherein upon a sale of the tokens by the seller to the buyer, the method further comprises moving the tokens from the seller escrow wallet to the master escrow wallet using a first address that identifies the seller and a second address that identifies the buyer.

6. The method of claim 1, wherein the seller escrow wallet only displays the content of the seller escrow wallet.

7. The method of claim 1, wherein the request is made by the secondary token marketplace.

8. The method of claim 1, wherein the method is performed via use of a plurality of networked computing nodes that maintain a distributed ledger of operations associated with the seller escrow wallet and the mast escrow wallet.

9. A system for operating a secondary token marketplace, the system comprising:
a processor; and
a computer-readable storage device storing instructions which, when executed by the processor, cause the processer to perform operations comprising:
creating a seller escrow wallet on the secondary token marketplace, wherein the seller escrow wallet displays a content of the seller escrow wallet, is non-custodial and maintains an ability to return tokens stored within the seller escrow wallet to an original account via a request;
transferring tokens purchased by a seller to the seller escrow wallet;
utilizing a master escrow wallet to facilitate a transfer of the tokens from the seller escrow wallet to a buyer wallet associated with a buyer;
upon a sale of the tokens by the seller to the buyer, moving the tokens from the seller escrow wallet to the master escrow wallet;
receiving a payment at the master escrow wallet from the buyer for the tokens; and
upon receiving the payment at the master escrow wallet, releasing the tokens to the buyer.

10. The system of claim 9, wherein the computer-readable storage device stores additional instructions which, when executed by the processor, cause the processer to perform operations further comprising:
issuing the buyer a buyer escrow wallet to deposit funds associated with the payment and accept delivery of the tokens.

11. The system of claim 9, wherein the computer-readable storage device stores additional instructions which, when executed by the processor, cause the processer to perform operations further comprising:
transferring the payment to the seller upon receiving the payment at the master escrow wallet.

12. The system of claim 9, wherein upon a sale of the tokens by the seller to the buyer, and wherein the computer-readable storage device stores additional instructions which, when executed by the processor, cause the processer to perform operations further comprising:
moving the tokens from the seller escrow wallet to the master escrow wallet using an address that identifies one of the seller or the buyer.

13. The system of claim 9, wherein upon a sale of the tokens by the seller to the buyer, and wherein the computer-readable storage device stores additional instructions which, when executed by the processor, cause the processer to perform operations further comprising:
moving the tokens from the seller escrow wallet to the master escrow wallet using a first address that identifies the seller and a second address that identifies the buyer.

14. The system of claim 9, wherein the seller escrow wallet only displays the content of the seller escrow wallet.

15. The system of claim 9, wherein the request is made by the secondary token marketplace.

16. The system of claim 9, wherein the operations are performed via use of a plurality of networked computing nodes that maintain a distributed ledger of transactions associated with the seller escrow wallet and the mast escrow wallet.

17. A computer-readable storage device storing instructions which, when executed by a plurality of computing devices managing a distributed ledger, cause the plurality of computing device to perform operations comprising:
creating a seller escrow wallet on a secondary token marketplace, wherein the seller escrow wallet displays a content of the seller escrow wallet, is non-custodial and maintains an ability to return tokens stored within the seller escrow wallet to an original account via a request;
transferring tokens purchased by a seller to the seller escrow wallet;
utilizing a master escrow wallet to facilitate a transfer of the tokens from the seller escrow wallet to a buyer wallet associated with a buyer;
upon a sale of the tokens by the seller to the buyer, moving the tokens from the seller escrow wallet to the master escrow wallet;
receiving a payment at the master escrow wallet from the buyer for the tokens; and
upon receiving the payment at the master escrow wallet, releasing the tokens to the buyer.

18. The computer-readable storage device of claim 17, wherein the computer-readable storage device stores additional instructions which, when executed by the plurality of computing devices, cause the plurality of computing devices to perform operations further comprising:
issuing the buyer a buyer escrow wallet to deposit funds associated with the payment and accept delivery of the tokens.

19. The computer-readable storage device of claim 17, wherein the computer-readable storage device stores additional instructions which, when executed by the plurality of computing devices, cause the plurality of computing devices to perform operations further comprising:
transferring the payment to the seller upon receiving the payment at the master escrow wallet.

20. The computer-readable storage device of claim 17, wherein the computer-readable storage device stores additional instructions which, when executed by the plurality of computing devices, cause the plurality of computing devices to perform operations further comprising:
upon a sale of the tokens by the seller to the buyer, moving the tokens from the seller escrow wallet to the master escrow wallet using an address that identifies one of the seller or the buyer.
